(19) United States
(12) Patent Application Publication
(10) Pub. No.: US 2025/0291519 A1
(43) Pub. Date: Sep. 18, 2025

(54) SSD VIRTUALIZATION WITH THIN PROVISIONING

(71) Applicant: Samsung Electronics Co., Ltd., Suwon-si (KR)

(72) Inventors: Somnath ROY, San Ramon, CA (US); Mark Allen GAERTNER, Fort Myers, FL (US); Daniel Lee HELMICK, Erie, CO (US); Sumanth JANNYAVULA VENKATA, Pleasanton, CA (US); Benixon ARUL DHAS, Gilroy, CA (US); Mayank SAXENA, Livermore, CA (US); Harsh ROOGI, Pleasanton, CA (US)

(21) Appl. No.: 19/004,210

(22) Filed: Dec. 27, 2024

Related U.S. Application Data
(60) Provisional application No. 63/564,987, filed on Mar. 13, 2024.
(60) Provisional application No. 63/650,393, filed on May 21, 2024.

(51) Int. Cl. G06F 3/06

(52) U.S. Cl. CPC G06F 3/0662; G06F 3/0604; G06F 3/0655; G06F 3/0679

(57) ABSTRACT

A Solid State Disk (SSD) is disclosed. The SSD may include a flash storage medium and a controller to access a data on the flash storage medium. The SSD may be configured to advertise a physical capacity of the flash storage medium to a Virtual Storage Manager (VSM).

### RELATED APPLICATION DATA

This application claims the benefit of U.S. Provisional Patent Application Ser. No. 63/650,393, filed May 21, 2024, which is incorporated by reference herein for all purposes.

### FIELD

The disclosure relates generally to storage, and more particularly to storage devices with varying yields.

### BACKGROUND

When storage devices are manufactured, they are expected to offer certain minimum amounts of storage. If that minimum is not met, the storage device may be rejected.

A need remains to use storage devices that may not offer certain minimum yields.

### BRIEF DESCRIPTION OF THE DRAWINGS

The drawings described below are examples of how embodiments of the disclosure may be implemented, and are not intended to limit embodiments of the disclosure. Individual embodiments of the disclosure may include elements not shown in particular figures and/or may omit elements shown in particular figures. The drawings are intended to provide illustration and may not be to scale.

FIG. 1 shows a machine including a virtual storage manager, according to embodiments of the disclosure.

FIG. 2 shows details of the machine of FIG. 1, according to embodiments of the disclosure.

FIG. 3 shows a view of the storage offered by the storage device of FIG. 1, according to embodiments of the disclosure.

FIG. 4 shows details of the storage device of FIG. 1, according to embodiments of the disclosure.

FIG. 5 shows details of the virtual storage manager of FIG. 1, according to embodiments of the disclosure.

FIG. 6 shows how storage may be allocated in the storage devices of FIG. 1, according to embodiments of the disclosure.

FIG. 7 shows the aggregation module of FIG. 5 generating a virtual storage device from the storage devices of FIG. 1, according to embodiments of the disclosure.

FIG. 8 shows the over-provisioning module of FIG. 5 factoring in the workload of an application, according to embodiments of the disclosure.

FIG. 9 shows how the virtual storage manager of FIG. 1 may allocate storage on the storage device of FIG. 1 at the request of the application of FIG. 8, according to embodiments of the disclosure.

FIG. 10 shows the storage device of FIG. 1 providing information to the virtual storage manager of FIG. 1, according to embodiments of the disclosure.

FIG. 11 shows a table that the mapping module of FIG. 5 may use to map an address used by the application of FIG. 8 to the storage device of FIG. 1 and an address on the storage device of FIG. 1, according to embodiments of the disclosure.

FIG. 12 shows how the virtual storage manager of FIG. 1 may put the storage device of FIG. 1 in read-only mode and may transfer data off the storage device of FIG. 1, according to embodiments of the disclosure.

FIG. 13A shows a flowchart of an example procedure for the virtual storage manager of FIG. 1 to advertise the usable capacity of the storage devices of FIG. 1, according to embodiments of the disclosure.

FIG. 13B continues the flowchart of an example procedure for the virtual storage manager of FIG. 1 to advertise the usable capacity of the storage devices of FIG. 1, according to embodiments of the disclosure.

FIG. 14 shows a flowchart of an example procedure for the over-provisioning module of FIG. 5 to determine over-provisioning for the storage device of FIG. 1, according to embodiments of the disclosure.

FIG. 15 shows a flowchart of an example procedure for the over-provisioning module of FIG. 5 to determine the over-provisioning for the storage device of FIG. 1, according to embodiments of the disclosure.

FIG. 16 shows a flowchart of an example procedure for the allocation module of FIG. 5 to reserve storage on the storage device of FIG. 1 for the application of FIG. 8, according to embodiments of the disclosure.

FIG. 17 shows a flowchart of an example procedure for the virtual storage manager of FIG. 1 to receive information from the storage device of FIG. 1, according to embodiments of the disclosure.

FIG. 18 shows a flowchart of an example procedure for the virtual storage manager of FIG. 1 to manage requests from the application of FIG. 8, according to embodiments of the disclosure.

FIG. 19 shows a flowchart of an example procedure for the virtual storage manager of FIG. 1 to set the storage device of FIG. 1 in read-only mode, according to embodiments of the disclosure.

FIG. 20 shows a flowchart of an example procedure for the virtual storage manager of FIG. 1 to transfer data from the storage device of FIG. 1 set in read-only mode, according to embodiments of the disclosure.

FIG. 21 shows a flowchart of an example procedure for the storage device of FIG. 1 to notify the virtual storage manager of FIG. 1 about its physical capacity, according to embodiments of the disclosure.

FIG. 22 shows a flowchart of an example procedure for the storage device of FIG. 1 to send an interrupt to the virtual storage manager of FIG. 1, according to embodiments of the disclosure.

### SUMMARY

A virtual storage manager may track the physical capacity of storage devices. The physical capacities of the storage devices may be aggregated to determine a usable capacity of a virtual storage device. Portions of the storage devices may then be allocated to applications.

### DETAILED DESCRIPTION

Reference will now be made in detail to embodiments of the disclosure, examples of which are illustrated in the accompanying drawings. In the following detailed description, numerous specific details are set forth to enable a thorough understanding of the disclosure. It should be understood, however, that persons having ordinary skill in the art may practice the disclosure without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first module could be termed a second module, and, similarly, a second module could be termed a first module, without departing from the scope of the disclosure.

The terminology used in the description of the disclosure herein is for the purpose of describing particular embodiments only and is not intended to be limiting of the disclosure. As used in the description of the disclosure and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The components and features of the drawings are not necessarily drawn to scale.

When storage devices, such as Not-AND (NAND) flash Solid State Drives (SSDs) are manufactured, each SSD is expected to yield some minimum capacity. This minimum capacity may exceed the advertised capacity: this excess may be termed over-provisioning. Over-provisioning may support garbage collection mechanisms, and may enable the SSD to use replacement blocks when other blocks in the SSD begin to fail. In this manner, SSDs may be expected to function for their advertised lifetime.

But most SSDs include some number of blocks that are considered failed blocks even at the time of manufacture. If enough blocks are considered failed blocks at the time of manufacture so that the SSD may not offer its minimum capacity, the SSD may be rejected for not offering its expected capacity.

Rather than discarding such SSDs, embodiments of the disclosure may enable SSDs to be used even if their actual capacity is below the expected yield for the SSD being manufactured. Rather than advertising a logical capacity that is less than the physical capacity of the SSD (with the excess being reserved for over-provisioning), the SSD may advertise its entire physical capacity. The SSD may advertise its capacity to a Virtual Storage Manager (VSM) executing under an operating system on a host processor. The VSM may track and aggregate the advertised storage capacities of all SSDs running on the computer, and may allocate storage to users and/or applications using thin provisioning. Using thin provisioning, the VSM may guarantee a user or an application a minimum amount of storage, but may actually allocate such storage to the user or the application when the user or the application actually requests to store data on the storage device. The VSM may allocate storage to the user or the application across all the SSDs, rather than on a specific SSD. The VSM may also present to the user or the application a virtual storage device, with the VSM mapping access requests to the virtual storage device to access requests on the physical storage devices.

In some embodiments of the disclosure, the VSM may also support over-provisioning across the SSDs, and may distribute the loads (particularly write requests) across the SSDs in an attempt to maximum overall performance.

In some embodiments of the disclosure, the SSDs may inform the VSM about changes in their actual capacity and/or their error rates. The SSDs may notify the VSM about the new information, the SSDs may let the VSM know that the SSDs have new information and may wait for the VSM to query for the new information, or the VSM may periodically poll the SSDs for any changes to their information. The VSM may then update how it manages the SSDs accordingly. In some embodiments of the disclosure, if an SSD is using so much of its capacity that the expected storage for over-provisioning is not available, the VSM may stop sending write requests to that SSD (redirecting those writes to another SSD), effectively turning the SSD into a read-only device. In other embodiments of the disclosure, the VSM may also start moving data off an SSD that looks like it is going to fail soon, so that the data is not lost. In still other embodiments of the disclosure, the VSM may inform the user or an administrator of the computer that the storage capacity of the computer should be increased by adding a new SSD.

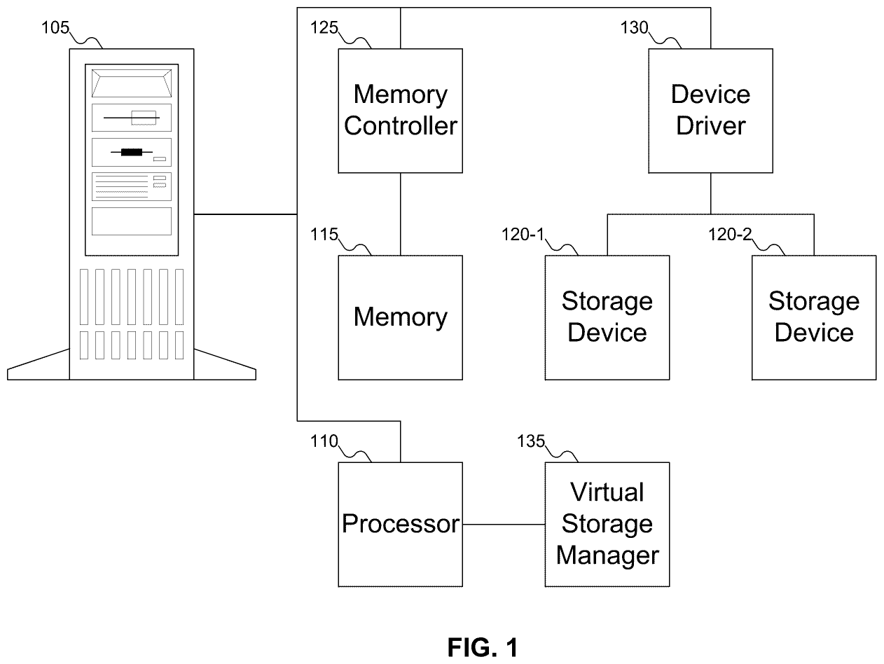

FIG. 1 shows a machine including a virtual storage manager, according to embodiments of the disclosure. In FIG. 1, machine 105, which may also be termed a host or a system, may include processor 110, memory 115, and storage devices 120-1 and 120-2 (which may be referred to collectively as storage devices 120). While FIG. 1 shows two storage devices 120-1 and 120-2, embodiments of the disclosure may include any number of storage devices 120.

Processor 110, which may also be referred to as a host processor, may be any variety of processor. (Processor 110, along with the other components discussed below, are shown outside the machine for case of illustration: embodiments of the disclosure may include these components within the machine.) While FIG. 1 shows a single processor 110, machine 105 may include any number (one or more, without bound) of processors, each of which may be single core or multi-core processors, each of which may implement a Reduced Instruction Set Computer (RISC) architecture or a Complex Instruction Set Computer (CISC) architecture (among other possibilities), and may be mixed in any desired combination.

Processor 110 may be coupled to memory 115. Memory 115, which may also be referred to as a main memory, may be any variety of memory, such as flash memory, Dynamic Random Access Memory (DRAM), Static Random Access Memory (SRAM), Persistent Random Access Memory, Ferroelectric Random Access Memory (FRAM), or Non-Volatile Random Access Memory (NVRAM), such as Magnetoresistive Random Access Memory (MRAM) etc. Memory 115 may also be any desired combination of different memory types, and may be managed by memory controller 125. Memory 115 may be used to store data that may be termed “short-term”: that is, data not expected to be stored for extended periods of time. Examples of short-term data may include temporary files, data being used locally by applications (which may have been copied from other storage locations), and the like.

Processor 110 and memory 115 may also support an operating system under which various applications may be running. These applications may issue requests (which may also be termed commands) to read data from or write data to either memory 115 or storage devices 120. Whereas memory 115 may be used to store data that is considered “short-term”, storage devices 120 may be used to store data that is considered “long-term”: that is, data that is expected to be retained for longer periods of time and that should be retained in a persistent manner, even if deliver of power to machine 105 should be interrupted. Storage devices 120 may be accessed using device driver 130. While FIG. 1 shows one device driver 130 being used to manage access to both storage devices 120, embodiments of the disclosure may include more than one device driver 130, each used to manage access to one or more of storage devices 120.

Storage devices 120 may be associated with an accelerator. Such an accelerator may be used for, for example, near-data processing. That is, the accelerator may be used to process data closer to storage devices 120, to reduce or eliminate transfer of data from storage devices 120 into memory 115. The use of an accelerator for near-data processing may also offload processing from processor 110, as the accelerator may perform such processing instead of processor 110. Like processor 105, such an accelerator may implement a Reduced Instruction Set Computer (RISC) architecture or a Complex Instruction Set Computer (CISC) architecture (among other possibilities), and may be implemented using a Central Processing Unit (CPU), a Field Programmable Gate Array (FPGA), an Application-Specific Integrated Circuit (ASIC), A System-on-a-Chip (SoC), a Graphics Processing Unit (GPU), a General Purpose GPU (GPGPU), a Neural Processing Unit (NPU), or a Tensor Processing Unit (TPU).

The combination of storage devices 120 and accelerator may also be referred to as a computational storage device, computational storage unit, computational storage device, or computational device. Storage devices 120 and an accelerator may be designed and manufactured as a single integrated unit, or the accelerator may be separate from storage devices 120. The phrase “associated with” is intended to cover both a single integrated unit including both a storage device and an accelerator and a storage device that is paired with an accelerator but that are not manufactured as a single integrated unit. In other words, a storage device and an accelerator may be said to be “paired” when they are physically separate devices but are connected in a manner that enables them to communicate with each other. Further, in the remainder of this document, any reference to storage devices 120 may be understood to refer to both storage devices 120 and the accelerator either as physically separate but paired (and therefore may include the other device) or to both devices integrated into a single component as a computational storage unit.

In addition, the connection between the storage device and the paired accelerator might enable the two devices to communicate, but might not enable one (or both) devices to work with a different partner: that is, the storage device might not be able to communicate with another accelerator, and/or the accelerator might not be able to communicate with another storage device. For example, the storage device and the paired accelerator might be connected serially (in either order) to the fabric, enabling the accelerator to access information from the storage device in a manner another accelerator might not be able to achieve.

While FIG. 1 uses the generic term “storage device”, embodiments of the disclosure may include any storage device formats that may be associated with computational storage, examples of which may include hard disk drives and Solid State Drives (SSDs). In addition, storage devices 120 may be of the same or different types. For example, storage device 120-1 might be an SSD, whereas storage device 120-2 might be a hard disk drive. Any reference to a specific type of storage device, such as an “SSD”, below should be understood to include such other embodiments of the disclosure.

Processor 105 and storage devices 120 may communicate across a fabric (not shown in FIG. 1). This fabric may be any fabric along which information may be passed. Such fabrics may include fabrics that may be internal to machine 105, and which may use interfaces such as Peripheral Component Interconnect Express (PCIe), Serial AT Attachment (SATA), or Small Computer Systems Interface (SCSI), among others. Such fabrics may also include fabrics that may be external to machine 105, and which may use interfaces such as Ethernet, Infiniband, or Fibre Channel, among others. In addition, such fabrics may support one or more protocols, such as Non-Volatile Memory Express (NVMe), NVMe over Fabrics (NVMe-oF), Simple Service Discovery Protocol (SSDP), or a cache-coherent interconnect protocol, such as the Compute Express Link® (CXL®) protocol, among others. (Compute Express Link and CXL are registered trademarks of the Compute Express Link Consortium in the United States.) Thus, such fabrics may be thought of as encompassing both internal and external networking connections, over which commands may be sent, either directly or indirectly, to storage devices 120. In embodiments of the disclosure where such fabrics support external networking connections, storage devices 120 might be located external to machine 105, and storage devices 120 might receive requests from a processor remote from machine 105.

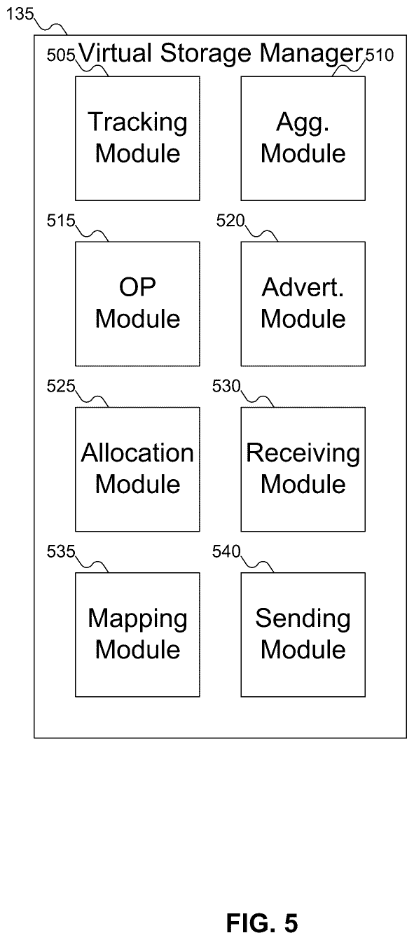

Machine 105 may also include virtual storage manager (VSM) 135. VSM 135 may be used to manage storage on storage devices 120. VSM 135 is discussed further with reference to FIGS. 5-19 below. VSM 135 may be implemented in any desired manner. For example, VSM 135 may be implemented as software executing under an operating system on processor 110: VSM 135 may execute in either kernel space or user space. Or, VSM 135 may be implemented as part of the physical interface to storage devices 120 (for example, as firmware or a chip on a printed circuit board, such as a motherboard connecting processor 110 and storage devices 120). Or, VSM 135 might be part of device driver 130. In some embodiments of the disclosure, where storage devices 120 support the NVMe protocol, VSM 135 may also be referred to as a virtual NVMe manager (VNM); other names may also be used with storage devices 120 support other protocols.

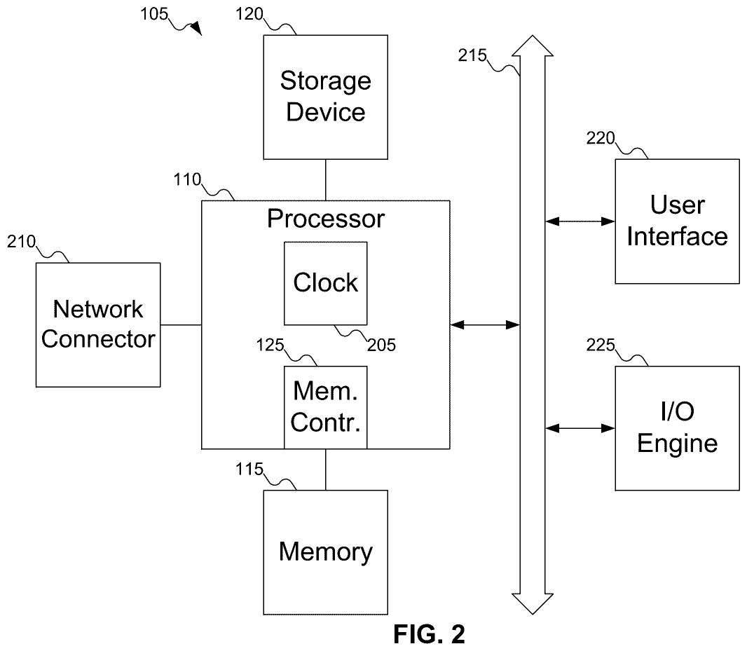

FIG. 2 shows details of the machine of FIG. 1, according to embodiments of the disclosure. In FIG. 2, typically, machine 105 includes one or more processors 110, which may include memory controllers 125 and clocks 205, which may be used to coordinate the operations of the components of the machine. Processors 110 may also be coupled to memories 115, which may include random access memory (RAM), read-only memory (ROM), or other state preserving media, as examples. Processors 110 may also be coupled to storage devices 120, and to network connector 210, which may be, for example, an Ethernet connector or a wireless connector. Processors 110 may also be connected to buses 215, to which may be attached user interfaces 220 and Input/Output (I/O) interface ports that may be managed using I/O engines 225, among other components.

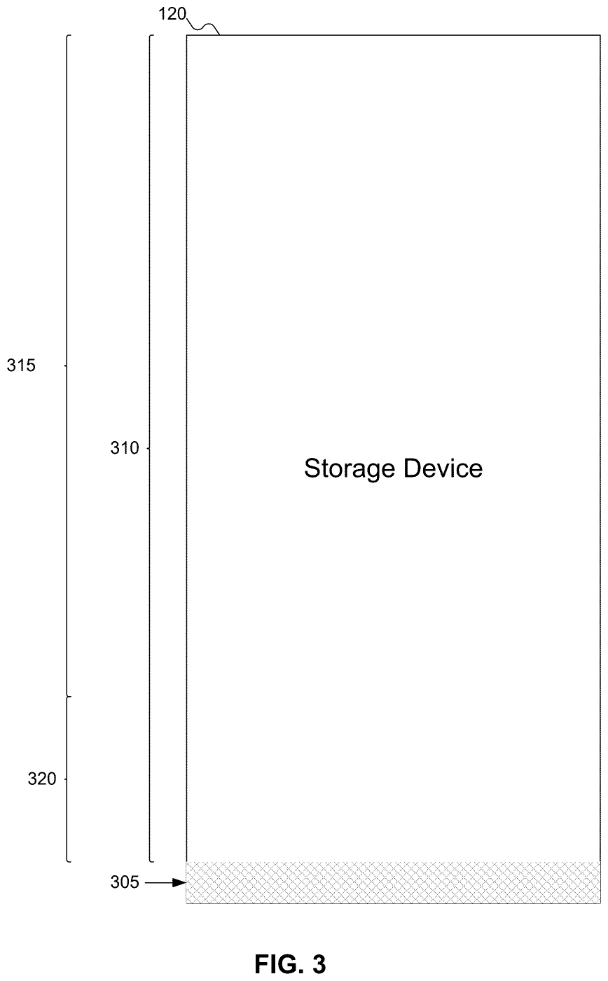

FIG. 3 shows a view of the storage offered by storage devices 120 of FIG. 1, according to embodiments of the disclosure. In FIG. 3, storage device 120 may be any type of storage device, such as an SSD or a hard disk drive. Storage device 120 may include some amount of storage, which may be divided into blocks, sectors, or other units. For simplicity, reference will be made to blocks in an SSD, but embodiments of the disclosure may include other units of storage in other types of storage devices, and blocks in an SSD may be replaced with other units of storage in other storage devices.

It is not unusual for storage device 120 to include failed blocks, even at the time of manufacture. That is, not every block in an SSD may be capable of storing data when written, or returning data when read. Thus, as shown in FIG. 3, storage device 120 may include failed blocks 305, shown with crosshatching. While FIG. 3 shows failed blocks 305 at one end of storage device 120, in practice the failed blocks may be scattered across storage device 120. The arrangement shown in FIG. 3 simply makes it easier to see what proportion of storage device 120 includes failed blocks relative to its full size.

Once failed blocks 305 are discounted, storage device 120 may have a physical capacity 310. Physical capacity 310 may be any size. For example, physical capacity 310 of storage device 120 might be 256 gigabytes (GB), 512 GB, 1 terabyte (TB), or any other desired size. If every block in storage device 120 was filled to capacity with data, then storage device 120 would be storing its physical capacity in data.

But some storage devices 120 do not necessarily advertise themselves as being able to store their entire physical capacity 310. That is, storage device 120 may reserve some percentage of its physical capacity for other uses. For example, consider SSDs. SSDs may support reading and/or writing data in units of pages, and there may be any desired number of pages in a single block in an SSD.

But while SSDs may read or write data in units of pages, SSDs might not support updating data in place. That is, once data is written to an SSD, that data may not be changed where it is stored. Instead, to update the data, the update may be written to a new page/block on the SSD, and the original data may be invalidated. To support the possibility of data being updated and being written to different pages/blocks, the SSD may include a flash translation layer, which may map an address received from processor 110 of FIG. 1 (or an application running on processor 110 of FIG. 1) to the physical address on the SSD where the data is actually stored. In this manner, processor 110 of FIG. 1 does not need to know the physical address where the data is stored, even if the data is moved during an update.

In addition, invalidating a page in a block in an SSD does not mean that new data may be written to the page. Before data may be written to a page, the page may need to be erased. But erasure may happen in units of blocks rather than pages. That is, the SSD might not support erasing just a single page: the entire block that includes that page may need to be erased.

Since erasure may happen in units of blocks, the ideal situation is that every page in the block has been invalidated (or was not written to in the first place): that is, that the block does not contain any valid data. But sometimes the SSD may need to erase a block even though the block contains some valid data. To erase that block, the SSD may program the valid data remaining in the block into page(s) in another block. Once all valid data has been programmed to another block, the block may be erased and new data may be written to the block. This process of moving any valid data in a block selected to be erased to a new block so that the block may then be erased may be termed garbage collection.

An SSD may also perform wear leveling. Each block in an SSD may be expected to support a predetermined number of program/erase cycles before the block is not guaranteed to successfully read or write data. In an attempt to keep the blocks in the SSD as balanced as possible in terms of the number of program/erase cycles, an SSD may perform wear levelling, which may bias the SSD toward writing data into blocks with lower program/erase cycle counts than blocks with higher program/erase cycle counts, and might even program data from a block in support of wear leveling (for example, moving data that has been stored in a block for a long time with a low program/erase cycle count so that the block might be used more, or moving data that is stored in a block with a high program/erase cycle count into another block so that the block with the high program/erase cycle count might be rotated “out of use” for a while).

As a result, garbage collection and/or wear leveling may require a valid block somewhere on the SSD to program valid data before a block may be erased. But if the SSD were to use its entire physical capacity 310 to store data, there might be no block available into which valid data might be programmed. To avoid this situation, the SSD may reserve a portion of physical capacity 310 to ensure that there are always blocks into which data may be programmed. This reserve portion of the SSD may be referred to as over-provisioning. Thus, for example, if an SSD is advertised as a 1 TB SSD and has 10% over-provisioning, then the SSD may actually offer only 900 GB of storage (the remaining 100 GB being used for over-provisioning).

In FIG. 3, physical capacity 310 is shown as divided into two portions: logical capacity 315 and over-provisioning 320. In FIG. 3, over-provisioning 320 is represented as approximately 20% of physical capacity 310, but embodiments of the disclosure may support any desired percentage of physical capacity 310 being reserved as over-provisioning 320. Logical capacity 315 may then be thought of as the difference between physical capacity 310 and over-provisioning 320. (Alternatively, logical capacity 315 may be set first, with the difference between physical capacity 310 and logical capacity 315 being reserved as over-provisioning 320.) Storage device 120 may then report logical capacity 315 as its available capacity, even though physical capacity 310 may be greater than logical capacity 315.

Oftentimes, this arrangement works fine. But as noted above, it is not unusual for storage device 120 to have failed blocks 305. If storage device 120 has enough failed blocks 305, then physical capacity 310 may be insufficient to both offer the target logical capacity 315 and the target over-provisioning 320. In that case, storage device 120 might be discarded as not meeting its manufacturing yield.

Embodiments of the disclosure offer a mechanism by which storage devices 120 may still be used even though storage device 120 might not meet its manufacturing yield (and therefore might not be sold as originally designed). Instead of discarding storage device 120, storage device 120 might include firmware that allows storage device 120 to report physical capacity 310, without partitioning physical capacity 310 into logical capacity 315 and over-provisioning 320.

Embodiments of the disclosure also offer an additional benefit. It may be expected that, over the life of storage device 120, additional blocks may fail, increasing the size of failed blocks 305. As failed blocks 305 increases, physical capacity 310 may decrease (since blocks that previously could be used to store data now might not be usable). With storage devices sold as offering a target capacity, the storage device might not be considered usable once failed blocks 305 grows enough to reduce logical capacity 315 below that target capacity. But with embodiments of the disclosure, storage device 120 might not have a target capacity to be considered functional, and storage device 120 may continue to be used even if physical capacity 310 drops below this target capacity.

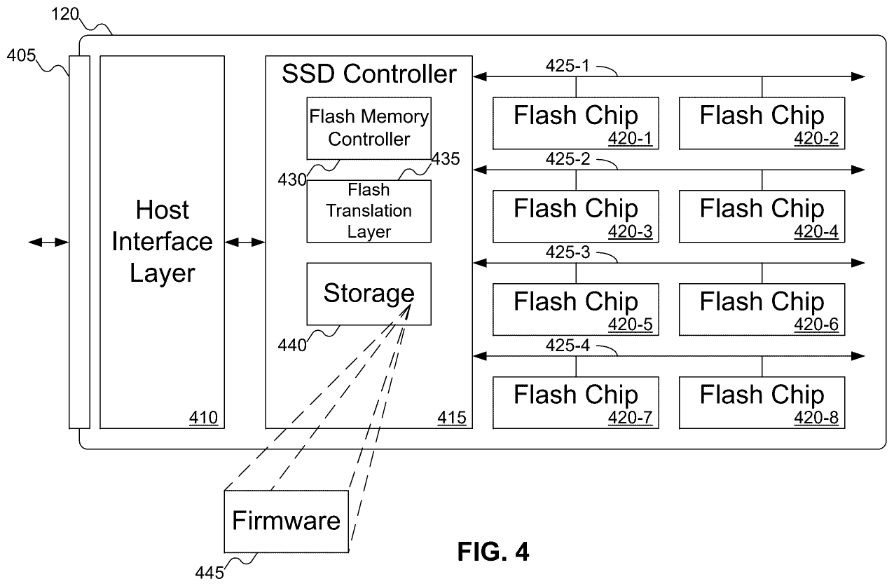

FIG. 4 shows details of storage device 120 of FIG. 1, according to embodiments of the disclosure. In FIG. 4, storage device 120 is shown using an implementation including SSD 120, but embodiments of the disclosure are applicable to any type of storage device that may support caching of data, as discussed below.

SSD 120 may include interface 405 and host interface layer 410. Interface 405 may be an interface used to connect SSD 120 to machine 105 of FIG. 1. Examples of such interfaces may include Serial AT Attachment (SATA), mSATA, Serial Attached Small Computer Systems Interface (SCSI) (SAS), NVMe, PCIe, U.2, M.2, and Enterprise and Datacenter Standard Form Factor (EDSFF): other interfaces are also possible. SSD 120 may include more than one interface 405: for example, one interface might be used for block-based read and write requests, and another interface might be used for key-value read and write requests. While FIG. 4 suggests that interface 405 is a physical connection between SSD 120 and machine 105 of FIG. 1, interface 405 may also represent protocol differences that may be used across a common physical interface. For example, SSD 120 might be connected to machine 105 using a U.2, EDSFF, or an M.2 connector, among other possibilities, and SSD 120 may support block-based requests and key-value requests: handling the different types of requests may be performed by a different interface 405. SSD 120 may also include a single interface 405 that may include multiple ports, each of which may be treated as a separate interface 405, or just a single interface 405 with a single port, and leave the interpretation of the information received over interface 405 to another element, such as SSD controller 415.

Host interface layer 410 may manage interface 405, providing an interface between SSD controller 415 and the external connections to SSD 120. If SSD 120 includes more than one interface 405, a single host interface layer 410 may manage all interfaces, SSD 120 may include a host interface layer 410 for each interface, or some combination thereof may be used.

SSD 120 may also include SSD controller 415 and various flash memory chips 420-1 through 420-8, which may be organized along channels 425-1 through 425-4. Flash memory chips 420-1 through 420-8 may be referred to collectively as flash memory chips 420, and may also be referred to as flash chips, memory chips, NAND chips, chips, or dies. Channels 425-1 through 425-4 may be referred to collectively as channels 425.

SSD controller 415 may manage sending read requests and write requests to flash memory chips 420 along channels 425. Controller 415 may also include flash memory controller 430, which may be responsible for issuing commands to flash memory chips 420 along channels 425. Flash memory controller 430 may also be referred to more generally as memory controller 430 in embodiments of the disclosure where storage device 120 stores data using a technology other than flash memory chips 420. Although FIG. 4 shows eight flash memory chips 420, four channels 425, and one flash memory controller 430, embodiments of the disclosure may include any number (one or more, without bound) of channels 425 including any number (one or more, without bound) of flash memory chips 420, and any number (one or more, without bound) of flash memory controllers 430.

Within each flash memory chip or die, the space may be organized into planes. These planes may include multiple erase blocks (which may also be referred to as blocks), which may be further subdivided into wordlines. The wordlines may include one or more pages. For example, a wordline for Triple Level Cell (TLC) flash media might include three pages, whereas a wordline for Multi-Level Cell (MLC) flash media might include two pages. In some embodiments of the disclosure, the page may be the smallest unit of data that may be written to or read from SSD 120; in other embodiments of the disclosure, the smallest unit of data that may be written to or read from SSD 120 may differ from the size of a page.

Erase blocks may also be logically grouped together by controller 415, which may be referred to as a superblock. This logical grouping may enable controller 415 to manage the group as one, rather than managing each block separately. For example, a superblock might include one or more erase blocks from each plane from each die in storage device 120. So, for example, if storage device 120 includes eight channels, two dies per channel, and four planes per die, a superblock might include 8×2×4=64 erase blocks.

SSD controller 415 may also include flash translation layer (FTL) 435 (which may be termed more generally a translation layer, for storage devices that do not use flash storage). FTL 435 may handle translation of logical block addresses (LBAs) or other logical IDs (as used by processor 110 of FIG. 1) and physical block addresses (PBAs) or other physical addresses where data is stored in flash chips 420. FTL 435, may also be responsible for tracking data as it is relocated from one PBA to another, as may occur when performing garbage collection and/or wear leveling.

SSD controller 415 may also include storage 440, which may store firmware 445. Firmware 445 may be a custom firmware that may report physical capacity 310 of FIG. 3 of storage device 120, rather than reporting logical capacity 315 of FIG. 3.

While FIG. 4 shows SSD controller 415 as including flash memory controller 430, flash translation layer 435, and storage 440, embodiments of the disclosure may have any, some, or all of these elements located outside SSD controller 415, without loss of generality.

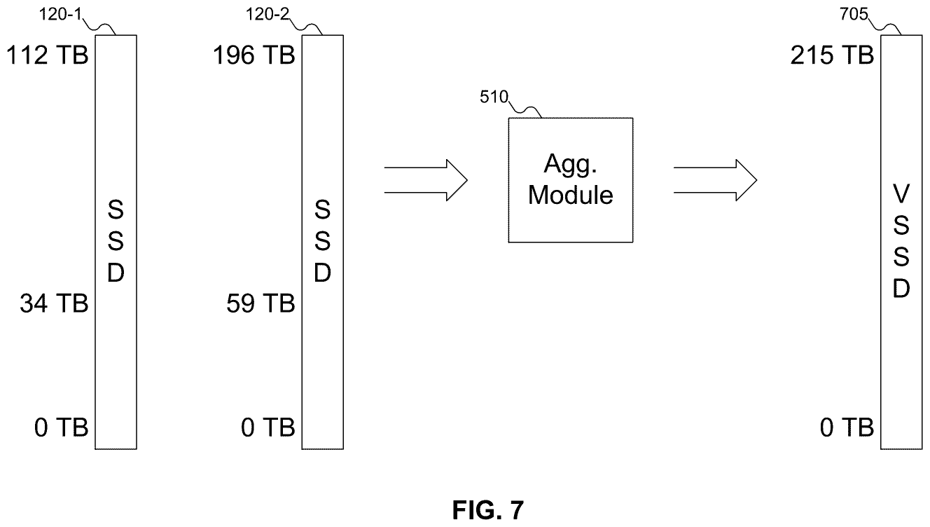

FIG. 5 shows details of virtual storage manager 135 of FIG. 1, according to embodiments of the disclosure. In FIG. 5, VSM 135 may include tracking module 505, aggregation module 510, over-provisioning module 515, advertising module 520, allocation module 525, receiving module 530, mapping module 535, and sending module 540. Tracking module 505 may track physical capacities 310 of FIG. 3 storage devices 120 of FIG. 1. Aggregation module 510 may determine the aggregate storage offered by storage devices 120 of FIG. 1 (and thus, the usable capacity of a virtual storage device that VSM 135 may offer to applications executing on processor 110 of FIG. 1). Over-provisioning module 515 may determine how much of physical capacities 310 of FIG. 3 of storage devices 120 of FIG. 1 may be reserved as over-provisioning 320 of FIG. 3 (but in contrast with how over-provisioning 320 was described with reference to FIG. 3 above, over-provisioning module 515 may manage over-provisioning 325 of FIG. 3, rather than storage devices 120 of FIG. 1 managing their own over-provisioning 325 of FIG. 3). Advertising module 520 may advertise to applications executing on processor 110 of FIG. 1 the usable capacity of the virtual storage device offered by VSM 135. Allocation module 525 may allocate portions of storage devices 120 of FIG. 1 to applications executing on processor 110 of FIG. 1. Receiving module 530 may receive requests to access (that is, read, write, or erase) data on storage devices 120 of FIG. 1 from applications executing on processor 110 of FIG. 1. Receiving module 530 may also receive responses from storage devices 120 of FIG. 1 to access requests received from the applications. Mapping module 535 may map the logical address used by the applications in the access requests received from the applications executing on processor 110 of FIG. 1 to addresses used by storage devices 120 of FIG. 1. For example, mapping module 535 might include a table that associates a host address used by the application with addresses used by storage devices 120 of FIG. 1. These addresses used by storage devices 120 of FIG. 1 might be either logical addresses or physical addresses on storage devices 120 of FIG. 1, depending on the implementation. Finally, sending module 540 may send requests to access data on storage device 120 of FIG. 1 to storage devices 120 of FIG. 1. Sending module 540 may also send responses received from storage device 120 of FIG. 1 to applications executing on processor 110 of FIG. 1. Modules 505-530 are discussed further with reference to FIGS. 7-20 below.

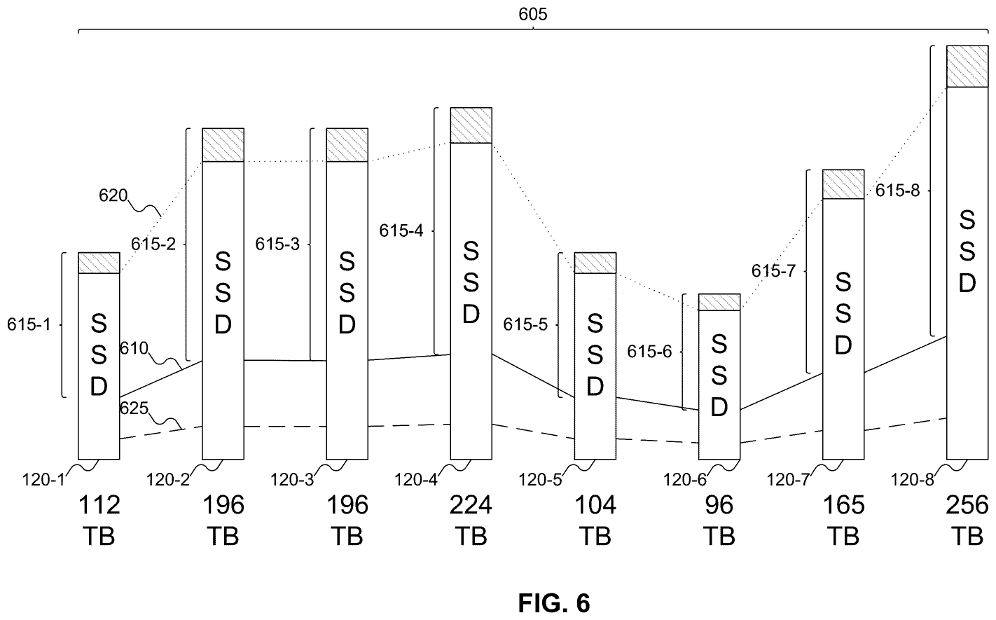

FIG. 6 shows how storage may be allocated in storage devices 120 of FIG. 1, according to embodiments of the disclosure. In FIG. 6, eight storage devices 120-1 through 120-8 are shown. As may be seen, each storage device 120 may have a different physical capacity 310 of FIG. 3, ranging from storage device 120-6 with a physical capacity of 96 TB to storage device 120-8 with a physical capacity of 256 TB. Embodiments of the disclosure may include storage devices 120 having any desired physical capacities, with 96-256 TB merely being an example range.

Storage devices 120 may notify VSM 135 of FIG. 3 of their physical capacities 310 of FIG. 3 (through tracking module 505 of FIG. 5). Then, when an application requests that storage be allocated for the application, VSM 135 of FIG. 1 (through allocation module 525 of FIG. 5) may allocate that storage across storage devices 120.

In some embodiments of the disclosure, VSM 135 of FIG. 1 may allocate from each storage device 120 in proportion to physical capacity 310 of each storage device 120. For example, in FIG. 6, the total of physical capacities 310 of FIG. 3 of storage devices 120 is 1,349 TB. This total may be considered usable capacity 605 for a virtual storage device offered by VSM 135 of FIG. 1. If an application requests, for example, 135 TB of storage be allocated, as 135 TB is approximately 10% of 1,349 TB, VSM 135 of FIG. 1 may allocate 10% of physical capacity 310 of FIG. 3 of each storage device 120. That is, VSM 135 of FIG. 1 might allocate 11 TB of storage device 120-1, 20 TB of storage device 120-2, and so on. (Note that the above example rounds values to the next integer: VSM 135 of FIG. 1 might be more precise than that.) In other embodiments of the disclosure, VSM 135 of FIG. 1 may allocate storage from storage devices 120 using other strategies: for example, by allocating from storage device 120-1 until storage device 120-1 is completely allocated, then allocating from storage device 120-2, and so on. Embodiments of the disclosure may apply any desired strategy to allocate storage from storage devices 120.

In some embodiments of the disclosure, VSM 135 of FIG. 1 (through allocation module 525 of FIG. 5) may distinguish between reserving storage on storage devices 120 for an application and allocating storage on storage devices 120 for that application. For example, an application may request that a particular amount of storage be allocated to that application. But rather than assigning storage explicitly to the application, VSM 135 of FIG. 1 may simply track that certain portions of storage devices 120 have been assigned or reserved for the application. Then, as the application begins to write data to be stored on the virtual storage device offered by VSM 135 of FIG. 1, VSM 135 of FIG. 1 may actually allocate sections of storage devices 120 to store information for the application. In other words, VSM 135 of FIG. 1 may use thin provisioning of storage devices 120. As an alternative, VSM 135 of FIG. 1 may use thick provisioning, where VSM 135 of FIG. 1 may allocate sections of storage devices 120 to the application when the application requests the storage, even if the application does not immediately write any data to storage devices 120.

For example, consider the situation where an application requests 945 TB of storage. 945 TB is approximately 70% of 1349 TB, and therefore VSM 135 might reserve approximately 70% of each of storage devices 120 for the application. This reserved storage may be represented as line 610, with the portions above line 610 being reserved for the application. But at this point, no data has actually be stored, and VSM 135 of FIG. 1 has not actually taken any steps to associate any portions of storage devices 120 with the application. But note that each portion has a size 615-1 through 615-8 (which may be referred to collectively as sizes 615), the sum of which should be at least as large as the storage requested by the application.

Continuing the example, at some point in time, the application might write 135 TB of data. This 135 TB of data may be stored in sections spread across storage devices 120, shown as the sections above line 620 (and shown with diagonal hatching). These sections may be considered allocated to the application, whereas other sections of storage devices 120 may be allocated to other applications (the only caveat being that the total storage across storage devices 120 for all applications should not exceed usable capacity 605 offered as the virtual storage device). In other words, data from any application may be stored anywhere on any storage device 120, provided that VSM 135 of FIG. 1 was able to reserve storage for the application on storage devices 120.

It might be noted above that the specification is distinguishing between the terms “portion” and “section”. For purposes of the application, “portion” may refer to storage space that has been reserved for an application but not yet physically allocated to store data for the application, whereas “section” may refer to storage space actually allocated to store data for an application. But in embodiments of the disclosure where allocating storage sets aside particular addresses within storage devices 120 for the application, the terms “portion” and “section” may be used interchangeably.

As noted above, embodiments of the disclosure may avoid storage devices 120 performing their own over-provisioning. In that case, VSM 135 of FIG. 1 (through over-provisioning module 515) may manage over-provisioning. That is, VSM 135 of FIG. 1 may ensure that a portion of usable capacity 605 may be “hidden” from applications executing on processor 110 of FIG. 1, so that storage devices 120 may use that excess storage for its own purposes, such as garbage collection and/or wear leveling. In some embodiments of the disclosure, VSM 135 of FIG. 1 may determine that some fraction of storage devices 120—for example, 30%—may be reserved for over-provisioning. Thus, the storage below line 610 may be considered used for over-provisioning. While in the example shown in FIG. 6 it may be coincidence that the application has requested 70% of the storage of storage devices 120, leaving 30% for over-provisioning, in other embodiments of the disclosure the amount of storage on storage devices 120 reserved for over-provisioning may be set independently of the amount of storage requested by the applications. Thus, for example, 30% of the storage on storage devices 120 may be reserved for over-provisioning in advance, after which the remaining 70% may be allocated to applications as requested. In still other embodiments of the disclosure, applications may request as much storage as they want (up to usable capacity 605), with whatever remains being used for over-provisioning. In still other embodiments of the disclosure, VSM 135 may determine how much storage on storage devices 120 to reserve for over-provisioning based on the workload of the application. But regardless of how over-provisioning is determined, VSM 135 of FIG. 1 may determine a logical capacity for each storage device 120, the sum of which may represent the usable capacity available for allocation by applications (and with the sum of all logical capacities and all over-provisioning totaling the sum of physical capacities 310 of FIG. 3 of storage devices 120).

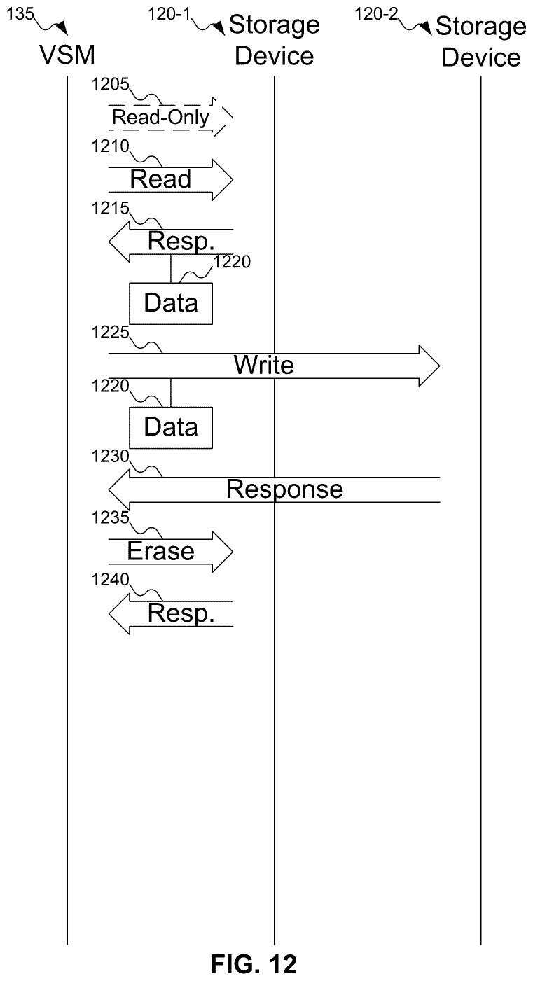

VSM 135 of FIG. 1 may also set lower bounds for over-provisioning of storage devices 120. For example, VSM 135 of FIG. 1 might determine that at least 10% of storage devices 120 should always be reserved for over-provisioning. This minimum may be seen as dashed line 625. Should the over-provisioning of a storage device 120 fall below this minimum, VSM 135 of FIG. 1 may take actions to protect that storage device 120: for example, to set storage device 120 in read-only mode. Read-only mode is discussed further with reference to FIG. 12 below.

FIG. 7 shows aggregation module 510 of FIG. 5 generating a virtual storage device from storage devices 120 of FIG. 1, according to embodiments of the disclosure. In FIG. 7, aggregation module 510 may receive the physical capacities 310 of FIG. 3 of storage devices 120, to determine a total physical capacity of virtual storage device 705. For example, storage devices 120-1 and 120-2 may offer physical capacities 310 of FIG. 3 of 112 TB and 196 TB, respectively. (While FIG. 7 only shows two storage devices 120-1 and 120-2 being aggregated using aggregation module 510, aggregation module 510 may aggregate as many storage devices 120 as desired, up to the total number of storage devices 120 in machine 105.) Aggregation module 510 may then determine that storage devices 120 offer a cumulative physical capacity of 308 TB.

But as storage devices 120-1 and 120-2 may reserve, for example, 34 TB and 59 TB, respectively, for over-provisioning, the logical capacities of storage device 120-1 and 120-2 might be only 215 TB total. Thus, aggregation module 510 may determine that the usable capacity of virtual storage device 705 might be only 215 TB, factoring in over-provisioning. Virtual storage device 705, as offered by VSM 135 of FIG. 1, might then include only 215 TB of storage.

VSM 135 of FIG. 1 may thus “expose” virtual storage device 705 as including addresses ranging from 0 to 215 TB. Applications may then write to any address in that range, and VSM 135 of FIG. 1 may manage the storage of data on storage devices 120 of FIG. 1.

In situations where VSM 135 of FIG. 1 may support multiple applications, there are various ways in which VSM 135 of FIG. 1 might operate. In some embodiments of the disclosure, VSM 135 of FIG. 1 may expose a single virtual storage device 705 to all applications, but may assign each application different address ranges “within” virtual storage device 705. In this manner, different applications may “write” to virtual storage device 705. In other embodiments of the disclosure, VSM 135 of FIG. 1 may offer separate virtual storage devices 705 to each application. In such embodiments of the disclosure, the capacity of virtual storage device 120 might be targeted to the storage requested by the application, rather than being a single virtual storage device 705 that effectively includes all available storage across storage devices 120.

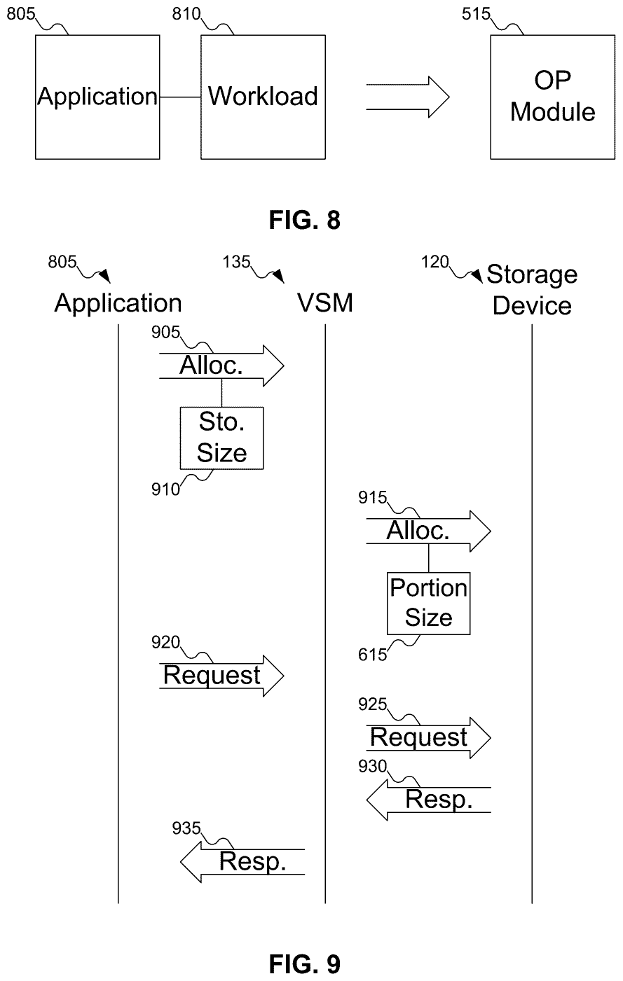

FIG. 8 shows over-provisioning module 515 of FIG. 5 factoring in the workload of an application, according to embodiments of the disclosure. In FIG. 8, application 805 is shown. Application 805 may provide over-provisioning module 515 with information about its workload, shown as workload 810. For example, workload 810 might indicate whether data is mostly to be read or written, or whether input/output operations operate on small data chunks or large data chunks. This information may be relevant to the wear on storage device 120, which may in turn be used to manage the over-provisioning of storage devices 120 of FIG. 1. For example, if workload 810 indicates that input/output operations are frequent and/or writes are small, it may be expected that storage devices 120 of FIG. 1 may wear out faster, and therefore a higher over-provisioning amount should be used (to shift wear to other storage devices 120 of FIG. 1). Or, if workload 810 indicates that data is mostly read, and not often written, then a lower over-provisioning amount may be used. Embodiments of the disclosure may also have over-provisioning module 515 factor in other workload data.

FIG. 9 shows how VSM 135 of FIG. 1 may allocate storage on storage device 120 of FIG. 1 at the request of application 805 of FIG. 8, according to embodiments of the disclosure. In FIG. 9, application 805 may issue request 905 to allocate data from virtual storage device 705 of FIG. 7. This request 905 may specify storage size 910, which may indicate how much space application 805 wants for its own use. Allocation module 525 of FIG. 5 may then determine how much space should be allocated or reserved from each of storage devices 120. In some embodiments of the disclosure, allocation module 525 of FIG. 5 may immediately issue allocation requests 915 to storage devices 120 to allocate portions 610 of FIG. 6, with each portion 610 of FIG. 6 including portion size 615 (that is, how much data should be allocated to application 805 from each storage device 120). Note that each portion 610 of FIG. 6 may be in proportion to physical capacity 310 of FIG. 3 of storage device 120.

At some point, application 805 may issue access request 920 to access (that is, read, write, or erase) data from virtual storage device 705 of FIG. 7. Receiving module 530 of FIG. 5 may receive request 920. Mapping module 535 of FIG. 5 may then map the address provided by application 805 to an address on storage devices 120 (and to one or more particular storage devices 120). Request 920 may then be modified to use the appropriate device identifier and address, and the modified request (shown as request 925) may be sent to storage device 120 by sending module 540 of FIG. 5. Eventually, storage device 120 may send response 930 (for example, that the data was written or erased, or to return the data requested to be read): response 930 may be received by receiving module 530 and sent to application 805 by sending module 540. (If necessary, VSM 135 may modify response 930 to produce response 935 that is sent to application 805: for example, to indicate that the response is coming from virtual storage device 705 of FIG. 7 rather than from storage device 120.)

As discussed above, in some embodiments of the disclosure, VSM 135 may reserve storage on storage devices 120 without actually allocating portions 610 of FIG. 6: allocation may be deferred until data is actually written to storage devices 120, and even then only enough storage is allocated to application 805 as is needed to store the data. In such situations, allocation requests 915 may be deferred until after request 920 is received (and issued then only if request 920 is a write request).

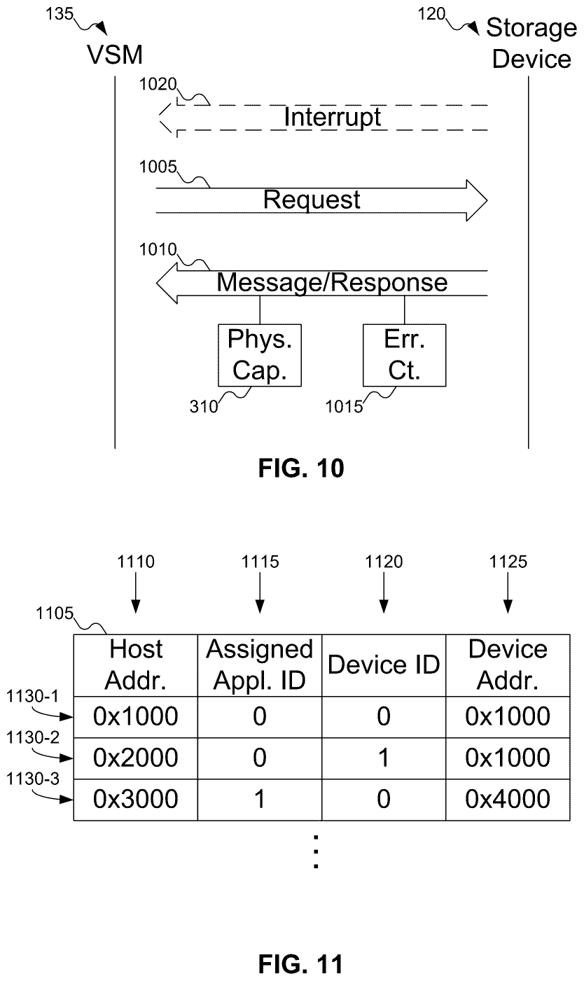

FIG. 10 shows storage device 120 of FIG. 1 providing information to virtual storage manager 135 of FIG. 1, according to embodiments of the disclosure. As discussed above, storage device 120 may want to notify VSM 135 about its current physical capacity 310, or other information. Storage device 120 may particularly want to notify VSM 135 about such information if the information in question has changed. For example, if storage device 120 has experienced block failures, physical capacity 310 of storage device 120 may have been reduced, and storage device 120 may want to notify VSM 135 about this change.

VSM 135 may issue request 1005 to storage device 120. In response, storage device 120 may issue message 1010, which may also be referred to as a response. Message 1010 may include information such as the current physical capacity 310 of storage device 120, or health metrics, such as error count 1015 of errors storage device 120 has experienced. VSM 135 may then factor this information into how it uses storage device 120. For example, if storage device 120 has experienced a reduction in its physical capacity 310, or has experienced a sufficient number of errors as indicated by error count 1015, or other health metrics indicate that storage device 120 is not functioning at an expected performance level, VSM 135 might set storage device 120 into read-only mode, so that no further data is written to storage device 120 (minimizing any further wear on storage device 120). For example, VSM 135 might direct a great proportion of traffic experiencing to healthy devices, such as those experiencing a lower number of drive writes per day.

The question might arise: why would VSM 135 send request 1005? The answer is simple: VSM 135 may wish to know about any relevant information that storage device 120 might have. There are several different ways in which VSM 135 may determine to send request 1005. In some embodiments of the disclosure, VSM 135 may periodically send messages 1005 to storage devices 120, polling them for their current information. In other embodiments of the disclosure, storage device 120 may send interrupt 1020: for example, storage device 120 might issue a Message Signaled Interrupt (MSI) or an MSI extended (MSI-X) interrupt. Upon receiving interrupt 1020, VSM 135 may know to send request 1005 for the current information from storage device 120.

FIG. 11 shows a table that mapping module 535 of FIG. 5 may use to map an address used by application 805 of FIG. 8 to storage device 120 of FIG. 1 and an address on storage device 120 of FIG. 1, according to embodiments of the disclosure. In FIG. 11, table 1105 is shown. Table 1105 may include various columns, such as host address 1110, assigned application identifier 1115, device identifier 1120, and device address 1125. Host address 1110 may be the address application 805 of FIG. 8 may use in access request 920 of FIG. 9. Host address 1110 may map to device address 1125 on a particular storage device 120 of FIG. 1 identified by device identifier 1120. Table 1105 may include various entries, such as entries 1130-1, 1130-2, and 1130-3 (which may be referred to collectively as entries 1130). For example, entry 1130-1 shows that host address 0x1000 may be stored at device address 0x1000 on storage device 120 of FIG. 1 with device identifier 0. Similarly, entry 1130-2 shows that host address 0x2000 may be stored at device address 0x1000 on storage device 120 of FIG. 1 with device identifier 1, and entry 1130-3 shows that host address 0x3000 may be stored at device address 0x4000 on storage device 120 of FIG. 1 with device identifier 0. While FIG. 11 shows three entries 1130, embodiments of the disclosure may include any number (zero or more, bounded only by the amount of memory or storage used to store table 1105) of entries 1130.

It is worth noting that device address 1125 may be either a physical address or a logical address. For example, if storage device 120 of FIG. 1 is a hard disk drive, device address 1125 might be a physical address on the hard disk drive where the data is stored. On the other hand, if storage device 120 of FIG. 1 is an SSD, then device address 1125 might be another logical address that SSD 120 of FIG. 1 may map (using flash translation layer 435 of FIG. 4) to a physical address on flash memory chips 420 of FIG. 4 where the data is actually stored.

Assigned application identifier 1115 may be used in situations where multiple applications 805 of FIG. 8 may access the same virtual storage device 705 of FIG. 7. (Where applications 805 of FIG. 8 each access a different virtual storage device 705 of FIG. 7, there may separate tables 1105 for each virtual storage device. But because all accesses to an individual virtual storage device 705 of FIG. 7 may be by only one application 805 of FIG. 8, assigned application identifier 1115 may be omitted. Alternatively, there might be just one table 1105 for all virtual storage devices 120, in which case assigned application identifier 1115 might be replaced with an assigned virtual storage device identifier.) By tracking which application 805 of FIG. 8 has accessed a particular host address 1110, VSM 135 may be able to prevent one application 805 of FIG. 8 from accessing the data of another application 805 of FIG. 8. Assigned application identifier 1115 may also be used in situations where two or more applications 805 of FIG. 8 might use the same host address 1110, providing a mechanism to distinguish between the repeated values of host address 1110.

When application 805 of FIG. 8 sends write request 920 to VSM 135 of FIG. 1, VSM 135 of FIG. 1 may determine which storage device 120 of FIG. 1 should be used to store the data. Mapping module 535 of FIG. 5 may then update table 1105 to reflect where (what storage device 120 of FIG. 1 and what device address 1125 on that storage device 120 of FIG. 1) the data will actually be written.

As an example of how table 1105 might be updated, each storage device 120 of FIG. 1 may have a stripe (similar to how Redundant Arrays of Independent Disks (RAIDs) may use stripes to store data across the disks). As data is to be written, the blocks that form a stripe on the first storage device 120 of FIG. 1 may be written. Once the stripe on the first storage device 120 of FIG. 1 is filled, data may be written to the blocks that form the stripe on the next storage device 120 of FIG. 1, and so on. The stripe may also store information about where data associated with a particular host address 1110 may be stored in the stripe, to enable retrieval of data. The overhead required to store such information is not large: perhaps 400-500 GB per petabyte (PB) (1 PB=1000 TB).

In some embodiments of the disclosure, VSM 135 of FIG. 1 may manage the storage of data on storage devices 120 of FIG. 1 in an attempt to optimize performance. That is, by distributing data across storage devices 120 of FIG. 1, embodiments of the disclosure may attempt to maximize data being written to or read from storage devices 120 of FIG. 1. As such, VSM 135 might effectively provide enhanced fault tolerance similar to RAID controllers or Erasure Coding Controllers, without the cost or performance penalty that RAID or Erasure Coding might impose. Thus, storage devices 120 of FIG. 1 may not need to implement RAID or Erasure Coding, either internally to storage devices 120 of FIG. 1 or across storage devices 120 of FIG. 1. But embodiments of the disclosure may additionally implement RAID or Erasure Coding, which may provide protection against data loss through redundancy or parity.

While mapping module 535 of FIG. 5 may track where data for each application 805 of FIG. 8 may be stored, there are other mechanisms that may be used to locate data. For example, there might be a static mapping between host addresses 1110 and device addresses 1125 across all devices. For example, referring back to FIG. 7, storage device 120-1 has a logical capacity of 78 TB, and storage device 120-2 has a logical capacity of 137 TB, for a total logical capacity of 215 TB. Host addresses that are between 0 and 78 TB may be written to storage device 120-1, and host addresses that are between 78 TB and 215 TB may be written to storage device 120-2. This static mapping has the benefit that there is no need to store table 1105 of FIG. 11: given host address 1110 of FIG. 11, device identifier 1120 of FIG. 11 and device address 1125 of FIG. 11 may be calculated directly. But because the dispersion of the data may depend on how application 805 of FIG. 8 uses the range of host addresses 1110 of FIG. 11, performance might be less than optimal, as data access requests 920 of FIG. 9 might bias toward a subset of storage devices 120 of FIG. 1, rather than using them all roughly equally (or roughly in proportion to their respective physical capacities 310 of FIG. 3).

FIG. 12 shows how virtual storage manager 135 of FIG. 1 may put storage device 120 of FIG. 1 in read-only mode and may transfer data off storage device 120 of FIG. 1, according to embodiments of the disclosure. In FIG. 12, VSM 135 may decide to put storage device 120-1 in read-only mode 1205, based on any desired criteria: for example, that the over-provisioning of storage device 120-1 has dropped below the minimum required level (such as dashed line 625 of FIG. 6), or because storage device 120-1 has begun to experience an increasing number of errors (as might be reported in error count 1015 of FIG. 10). Note that setting storage device 120-1 to read-only mode 1205 does not necessarily involve any changes in the operation of storage device 120-1: read-only mode 1205 may only impact how VSM 135 interacts with storage device 120-1. For example, VSM 135 may choose not to send any more data to be written to storage device 120, and may only read data from storage device 120. Thus, read-only mode 1205 is shown in FIG. 12 with a dashed arrow, as VSM 135 might not actually send any message or signal to storage device 120-1. But VSM 135 may continue to send read requests 1210 to storage device 120-1 to read data that is stored on storage device 120-1, with storage device 120-1 responding with response 1215, including data 1220.

In some situations, it may be desirable to move data off of storage device 120-1 while in read-only mode 1205. For example, if storage device 120-1 has been experiencing errors, it might be expected that storage device 120-1 may fail soon, and that it be desirable to move data off of storage device 120-1 before that failure occurs. In that case, VSM 135 may use read request 1210 to read data 1220 off of storage device 120-1, and may send write request 1225 to storage device 120-2 to write data 1220 to a new location. After storage device 120-2 sends response 1230, VSM 135 may issue erase request 1235 to erase the data from storage device 120-1, to which storage device 120-1 may respond with response 1240.

There are several points worth noting. First, VSM 135 does not have to transfer data 1220 from storage device 120-1 to storage device 120-2. That is, VSM 135 may continue to use storage device 120-1 for the data already stored thereon, without necessarily migrating the data to storage device 120-2.

Second, if VSM 135 does decide to transfer data from storage device 120-1 to storage device 120-2, VSM 135 may perform that transfer at any desired time. For example, VSM 135 might wait until data 1220 is read from storage device 120-1 as part of access request 920 of FIG. 9 issued by application 805 of FIG. 8, thereby leveraging the fact that data 1220 was being read anyway. Or, VSM 135 might issue read request 1210 to transfer data 1220 to storage device 120-2 when activity on storage devices 120-1 and 120-2 are low, so that the data migration has minimal (or no) impact on applications issuing access requests. Or, if there is concern that storage device 120-1 might fail immediately, VSM 135 might immediately start transferring data from storage device 120-1 to storage device 120-2.

Third, although FIG. 12 shows data being transferred between storage device 120-1 and 120-2, data from storage device 120-1 may be migrated to more than one other storage device 120.

Fourth, although not shown in FIG. 12, when data 1220 is migrated from storage device 120-1 to storage device 120-2, table 1105 of FIG. 11 (or any other data structure that might be used by mapping module 535 of FIG. 5) may be updated to reflect the new location of data 1220. This update may occur at any time: for example, after data 1220 is written to storage device 120-2 and before data 1220 is erased from storage device 120-1.

Fifth, although FIG. 12 shows VSM 135 sending erase request 1235 to storage device 120-1, erasing data 1220 from storage device 120 is not required. Given that storage device 120-1 may be expected to fail soon, issuing erase request 1235 might be an unnecessary operation, and data 1220 may be permitted to stay (unused) on storage device 120-1.

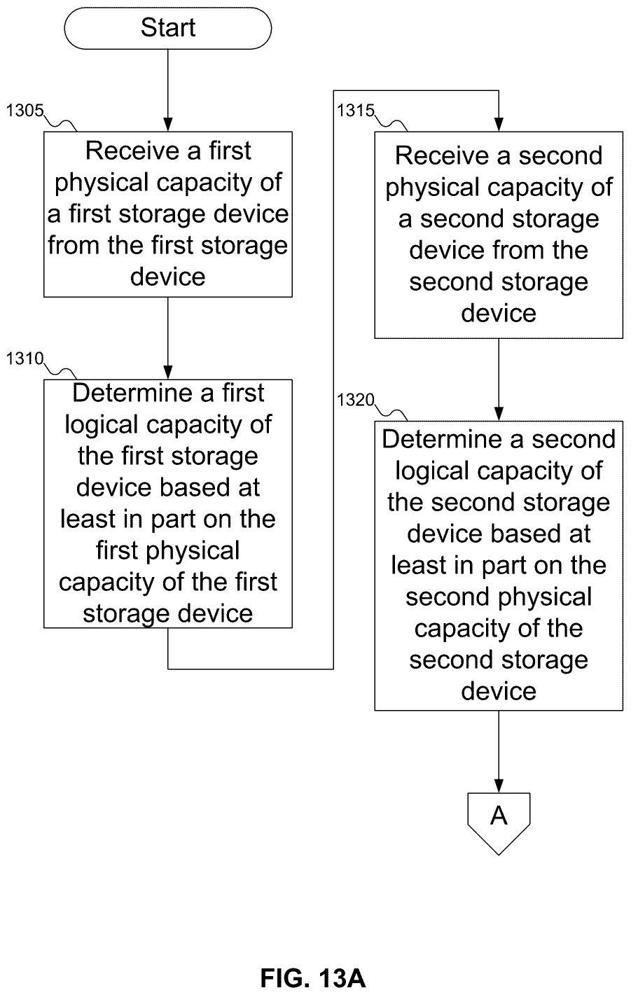

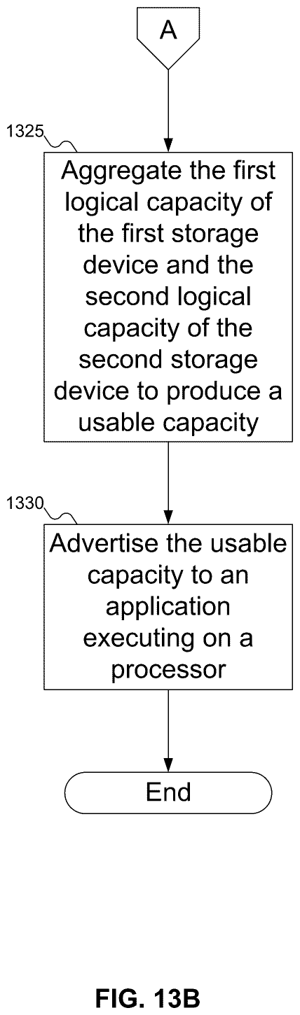

FIGS. 13A-13B show a flowchart of an example procedure for virtual storage manager 135 of FIG. 1 to advertise the usable capacity of storage devices 120 of FIG. 1, according to embodiments of the disclosure. In FIG. 13A, at block 1305, tracking module 505 of FIG. 5 may receive physical capacity 310 of FIG. 3 of storage device 120-1 of FIG. 1. At block 1310, VSM 135 of FIG. 1 may determine a logical capacity for storage device 120-1 of FIG. 1. At block 1315, tracking module 505 may receive physical capacity 310 of FIG. 3 of storage device 120-2 of FIG. 1. At block 1320, VSM 135 of FIG. 1 may determine a logical capacity for storage device 120-2 of FIG. 1.

At block 1325 (FIG. 13B), aggregation module 510 of FIG. 5 may aggregate the logical capacities of storage devices 120-1 and 120-2 of FIG. 1. Finally, at block 1330, advertising module 520 of FIG. 5 may advertise that virtual storage device 705 of FIG. 7 offered by VSM 135 of FIG. 1 includes usable capacity 605 of FIG. 6.

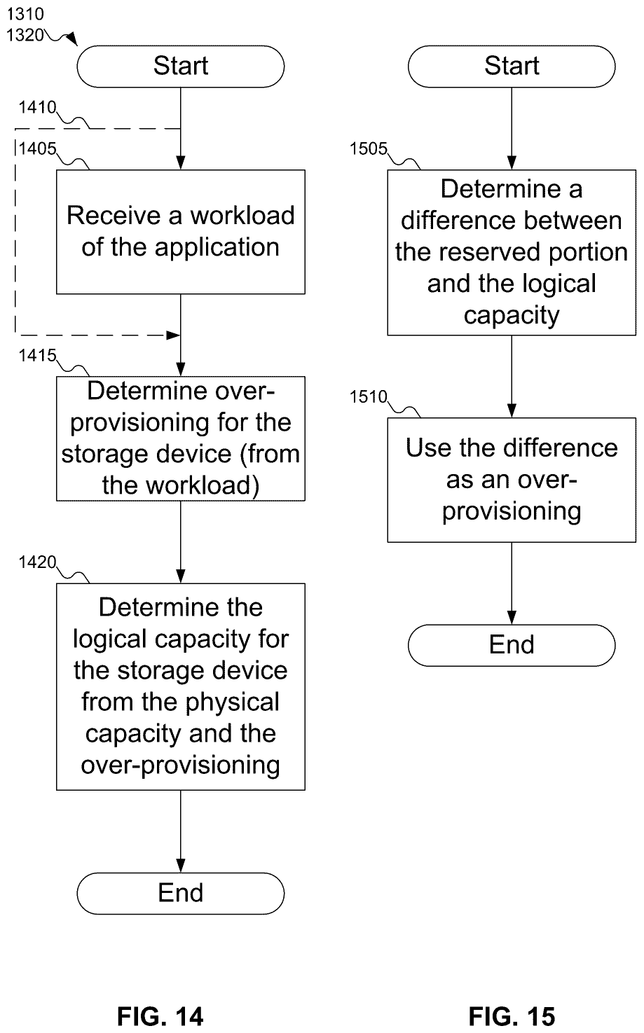

FIG. 14 shows a flowchart of an example procedure for over-provisioning module 515 of FIG. 5 to determine over-provisioning for storage device 120 of FIG. 1, according to embodiments of the disclosure. In FIG. 14, at block 1405, over-provisioning module 515 of FIG. 5 may receive workload 810 of FIG. 8 from application 805 of FIG. 8. Note that block 1405 may be omitted, as shown by dashed line 1410. At block 1415, over-provisioning module 515 of FIG. 5 may determine an over-provisioning for storage device 120 of FIG. 1, which may be based in part on workload 810 of FIG. 8 received from application 805 of FIG. 8. Finally, at block 1420, over-provisioning module 515 of FIG. 5 may determine the logical capacity of storage device 120 of FIG. 1 based on physical capacity 310 of FIG. 3 of storage device 120 and the over-provisioning determined in block 1415.

While FIG. 14 shows one way in which over-provisioning module 515 of FIG. 5 may function (to determine the over-provisioning of storage device 120 of FIG. 1 first, and then to determine the logical capacity of storage device 120 of FIG. 1), there are other ways in which over-provisioning may be determined. FIG. 15 shows an alternative approach for over-provisioning module 515 of FIG. 5 to determine the over-provisioning for storage device 120 of FIG. 1, according to embodiments of the disclosure.

In FIG. 15, at block 1505, the logical capacity of storage device 120 of FIG. 1 may be determined first. Then, the difference between physical capacity 310 and the logical capacity may be determined. Finally, at block 1510, that difference may be used as the over-provisioning of storage device 120 of FIG. 1.

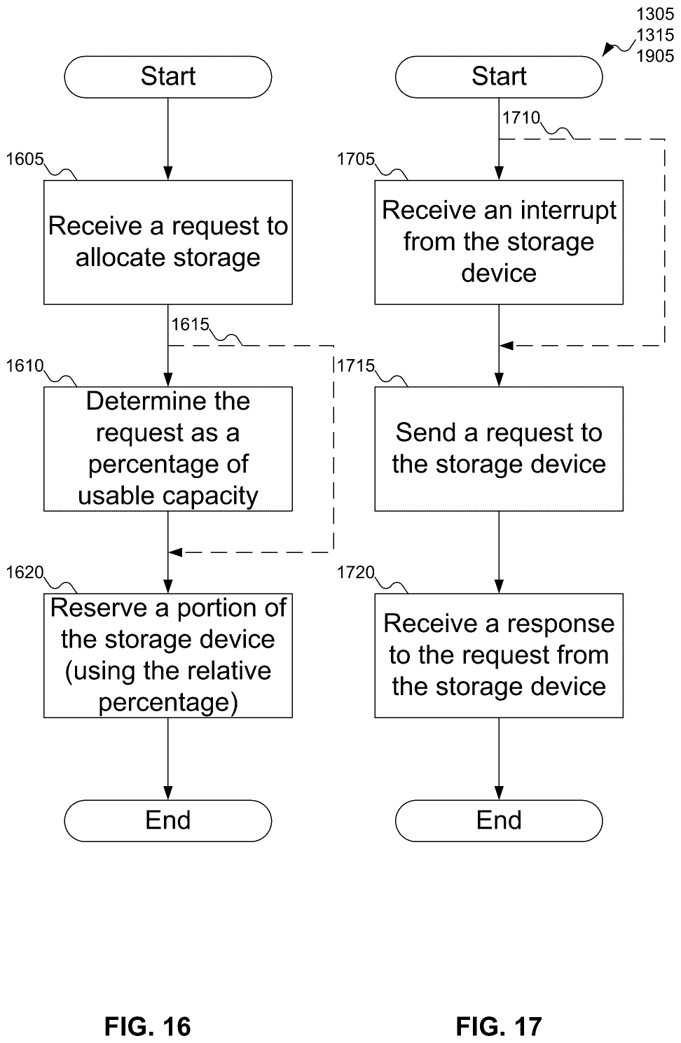

FIG. 16 shows a flowchart of an example procedure for allocation module 525 of FIG. 5 to reserve storage on storage device 120 of FIG. 1 for application 805 of FIG. 8, according to embodiments of the disclosure. In FIG. 16, at block 1605, allocation module 525 of FIG. 5 may receive request 905 of FIG. 9 from application 805 of FIG. 8 to request storage be allocated for application 805 of FIG. 8. At block 1610, allocation module 525 of FIG. 5 may determine the relative percentage of storage size 910 of FIG. 9 in request 905 of FIG. 9 from application 805 of FIG. 8. This relative percentage may be used to determine the relative allocations from storage devices 120 of FIG. 1 to satisfy storage size 910 of FIG. 9 in request 905 of FIG. 9. But embodiments of the disclosure may include other ways to determine how large each portion 610 of FIG. 6 of storage devices 120 of FIG. 1 may be, and therefore block 1610 may be omitted, as shown by dashed line 1615. Finally, at block 1620, allocation module 525 of FIG. 5 may reserve portion 610 of FIG. 6 of storage device 120 of FIG. 1 (if thin provisioning is used) or may send allocation request 915 of FIG. 9 to storage device 915 of FIG. 9 to allocate portion 610 of FIG. 6 (if thick provisioning is used).

FIG. 17 shows a flowchart of an example procedure for virtual storage manager 135 of FIG. 1 to receive information from storage device 120 of FIG. 1, according to embodiments of the disclosure. In FIG. 17, at block 1705, VSM 135 of FIG. 1 may receive interrupt 1020 of FIG. 10 from storage device 120 of FIG. 1. As discussed with reference to FIG. 10 above, VSM 135 of FIG. 1 might periodically poll storage devices 120 of FIG. 1 for new information, and therefore block 1705 may be omitted, as shown by dashed line 1710. At block 1715, VSM 135 of FIG. 1 may send request 1005 of FIG. 10 to storage device 120 of FIG. 1. Finally, at block 1720, VSM 135 of FIG. 1 may receive response 1010 of FIG. 10 from storage device 120 of FIG. 1, which may include information, such as physical capacity 310 or error count 1015 of FIG. 10.

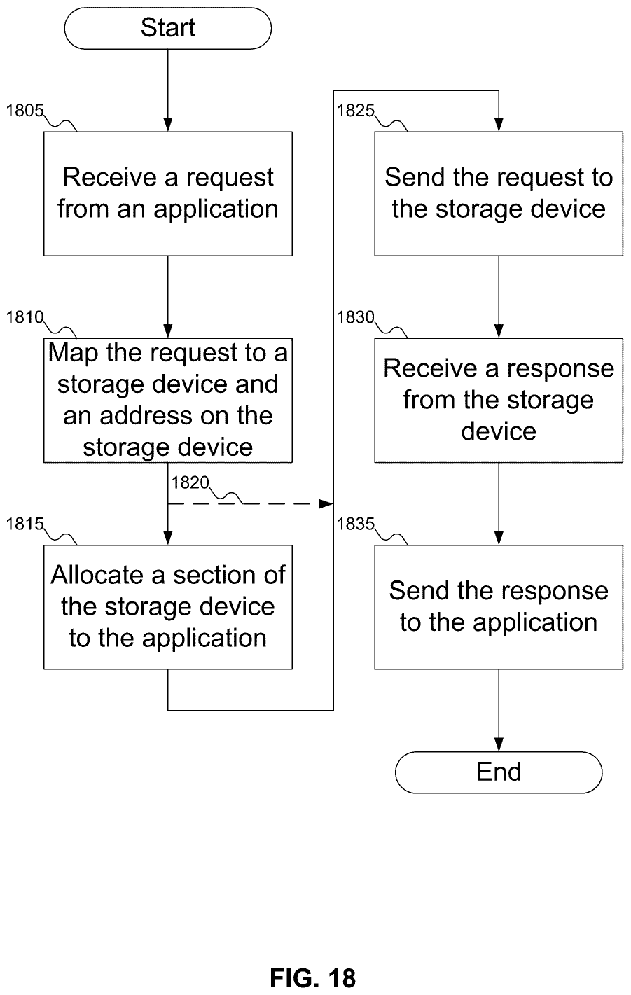

FIG. 18 shows a flowchart of an example procedure for virtual storage manager 135 of FIG. 1 to manage requests from application 805 of FIG. 8, according to embodiments of the disclosure. In FIG. 18, at block 1805, VSM 135 of FIG. 1 may receive request 920 of FIG. 9 from application 805 of FIG. 8. At block 1810, mapping module 535 of FIG. 5 may map host address 1110 of FIG. 11 to device address 1125 of FIG. 11 (and to identify storage device 120 of FIG. 1 that stores the data). As a particular example, if request 920 of FIG. 9 is a write request, block 1810 may involve determining which storage device 120 of FIG. 1 on which to store the data to be written: VSM 135 of FIG. 1 may select storage device 120 of FIG. 1 to store the data based on, for example, the available capacity of storage device 120 of FIG. 1 relative to other storage devices 120 of FIG. 1, and/or the relative health metrics of storage devices 120 of FIG. 1, and may select device address 1125 of FIG. 11 for that storage device 120 of FIG. 1. VSM 135 of FIG. 1 may then update mapping module 535 of FIG. 5 to reflect that host address 1110 of FIG. 11 may be mapped to device address 1125 of FIG. 11.

At block 1815, allocation module 525 of FIG. 5 may allocate a section of storage on storage device 120 of FIG. 1. Note that this allocation may have already occurred (for example, at block 1620 of FIG. 16). But if thin provisioning is being used, then the section of storage device 120 of FIG. 1 may be allocated at this time. If request 920 of FIG. 9 is not a write request to write data, or if thin provisioning is not used, then block 1815 may be omitted, as shown by dashed line 1820.

At block 1825, sending module 540 of FIG. 5 may send request 925 of FIG. 9 to storage device 120 of FIG. 1. At block 1830, receiving module 530 of FIG. 5 may receive response 930 of FIG. 9 from storage device 120 of FIG. 1. Finally, at block 1835, sending module 540 of FIG. 5 may send response 930 of FIG. 9 (appropriately modified, if necessary) to application 805 of FIG. 8.

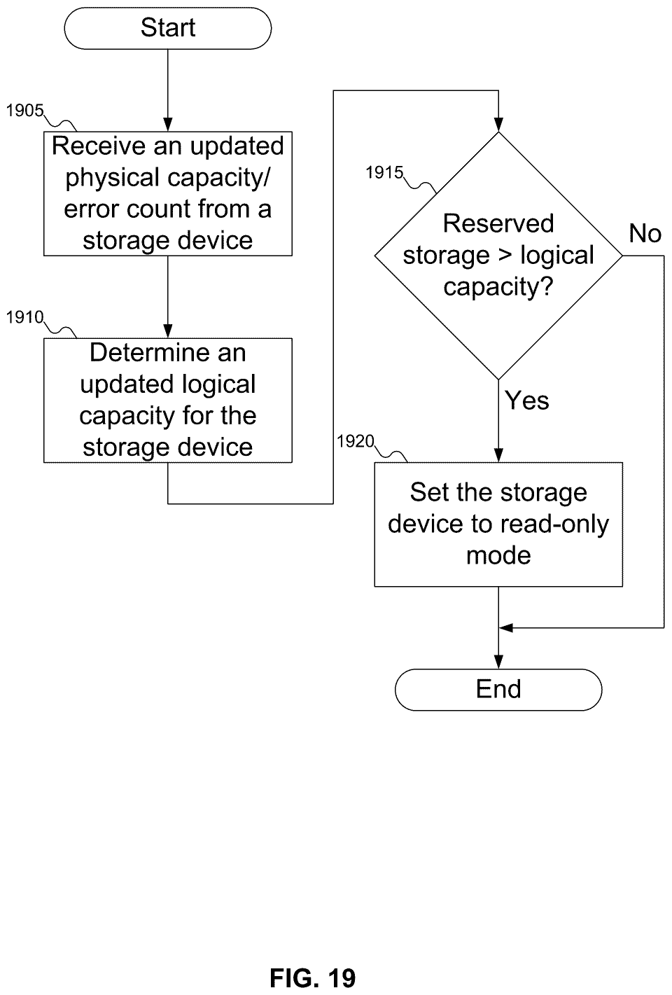

FIG. 19 shows a flowchart of an example procedure for virtual storage manager 135 of FIG. 1 to set storage device 120 of FIG. 1 in read-only mode 1205 of FIG. 12, according to embodiments of the disclosure. In FIG. 19, at block 1905, VSM 135 of FIG. 1 may receive updated physical capacity 310 of FIG. 3 from storage device 120 of FIG. 1. At block 1910, VSM 135 of FIG. 1 may determine an updated logical capacity for storage device 120 of FIG. 1. At block 1915, VSM 135 of FIG. 1 may compare the reserved storage (that is, storage that has been requested by applications) on storage device 120 of FIG. 1 to the logical capacity of storage device 120 of FIG. 1. Then, if the reserved storage is greater than the logical capacity of storage device 120 of FIG. 1, at block 1920 VSM 135 of FIG. 1 may set storage device 120 of FIG. 1 in read-only mode 1205 of FIG. 12.

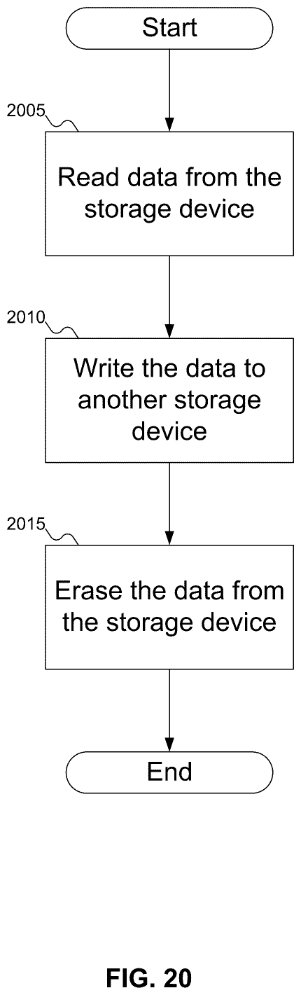

FIG. 20 shows a flowchart of an example procedure for virtual storage manager 135 of FIG. 1 to transfer data from storage device 120 of FIG. 1 set in read-only mode 1205 of FIG. 12, according to embodiments of the disclosure. In FIG. 20, at block 2005, VSM 135 of FIG. 1 may send read request 1210 of FIG. 12 to read data 1220 of FIG. 12 from storage device 120 of FIG. 1 in read-only mode 1205 of FIG. 12. At block 2010, VSM 135 of FIG. 1 may send write request 1225 of FIG. 12 to write data 1220 of FIG. 12 to another storage device 120 of FIG. 1. Finally, at block 2015, VSM 135 of FIG. 1 may send erase request 1235 of FIG. 12 to storage device 120 of FIG. 1 in read-only mode 1205 of FIG. 12 to erase data 1220 of FIG. 12.

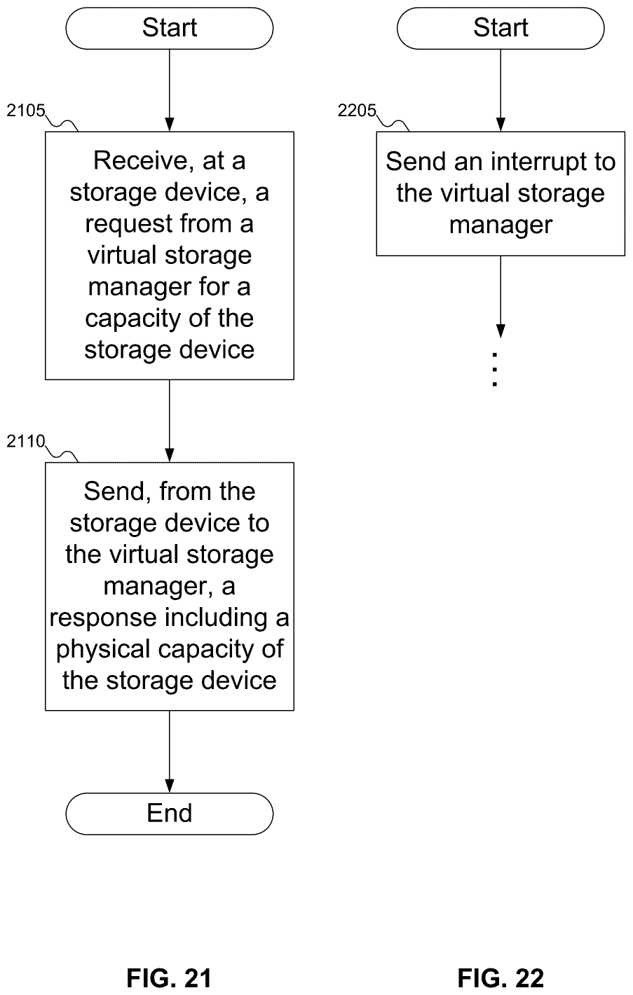

FIG. 21 shows a flowchart of an example procedure for storage device 120 of FIG. 1 to notify virtual storage manager 135 of FIG. 1 about its physical capacity, according to embodiments of the disclosure. In FIG. 11, at block 2105, storage device 120 of FIG. 1 may receive request 1005 of FIG. 10 from VSM 135 of FIG. 1, requesting information, such as physical capacity 310 of FIG. 3 of storage device 120 of FIG. 1, from storage device 120 of FIG. 1. Then, at block 2110, storage device 120 of FIG. 1 may send response 1010 of FIG. 10 to VSM 135 of FIG. 1, which may include information, such as physical capacity 310 or error count 1015 of FIG. 10.

FIG. 22 shows a flowchart of an example procedure for storage device 120 of FIG. 1 to send an interrupt to virtual storage manager 135 of FIG. 1, according to embodiments of the disclosure. In FIG. 22, at block 2205, storage device 120 of FIG. 1 may send interrupt 1020 of FIG. 10 to VSM 135 of FIG. 1, which may trigger VSM 135 of FIG. 1 to send request 1005 of FIG. 10 as described in FIG. 21.

In FIGS. 13A-22, some embodiments of the disclosure are shown. But a person skilled in the art will recognize that other embodiments of the disclosure are also possible, by changing the order of the blocks, by omitting blocks, or by including links not shown in the drawings. All such variations of the flowcharts are considered to be embodiments of the disclosure, whether expressly described or not.

Embodiments of the disclosure may enable a storage device to be used regardless of its yield. A virtual storage manager may receive the physical capacities of storage devices and may manage allocation of storage on storage devices. The virtual storage manager may also manage over-provisioning on the storage devices. enabling the use of storage devices regardless of yield (and therefore the use of storage devices whose yields might be insufficient to be used as storage devices with predetermined yields offers a technical advantage by avoiding discarding storage devices with insufficient yields.

Not-And (NAND) memory in a Solid State Drive (SSD) is composed of a fixed number of erasure blocks. When manufactured, a specified number of blocks are needed in each NAND for guaranteeing a particular logical capacity. Additional blocks may be included as over-provisioning or spare blocks, in case the blocks initially offered by the SSD should fail.

Every NAND memory may contain initial defective blocks. The remaining good blocks in each NAND memory should meet or exceed the specified number of necessary blocks.

If a NAND memory includes too many of the defective blocks, the SSD might not meet the manufacturing yield requirement. As a consequence, the NAND memory may be wasted.

In addition, as noted above, blocks may also fail during the lifetime of the SSD in the field. If too many blocks fail in the field, the SSD may no longer guarantee its stated capacity. The failure of an SSD in the field may be a serious inconvenience for the customer even if majority of the NAND memory in the SSD are good. At least, the customer should be able to use the drive in a read-only mode.

Embodiments of the disclosure may enable an SSD to be used even if it does not meet the logical capacity or the spare blocks requirement (over-provisioning) of the drive. There may be SSDs with varying capacities and an intelligent system software, such as a Virtual NVMe Manager (VNM) or a Virtual Storage Manager (VSM), to manage these variable capacity drives. The VNM may provide a thin provisioned range to the application, lower bounded to the guaranteed capacity requested by an application. Each SSD may include firmware that will present the entire physical capacity of the SSD as a logical capacity rather than exposing a fixed logical capacity to the VNM layer. The SSD may avoid maintaining extra over-provisioning: over-provisioning may exist in the form of unwritten logical capacity. The VNM may manage the over-provisioning at the system level.

An SSD may not need to fail in the field even if it may not guarantee the original fixed logical capacity. An SSD may shrink its capacity dynamically based on the error rates and number of good blocks available. Basically, the SSD itself will be thin provisioned.

An SSD may report this new capacity using the Non-Volatile Memory Express (NVMe) Namespace Capacity (NCAP) field. The VNM may deal with these dynamically variable drive capacities and do it best effort to honor the guaranteed aggregated capacity promised (which may be less than the total available capacity of the SSDs).

Based on the usable capacity requirement, the VNM may statically allocate a fixed percentage from each drive and aggregate those percentages across the drives. The VNM may expose “N” number of thin provisioned virtualized NVMe drives, by equally dividing the entire static address range. The VNM may make a best effort not to fall below this aggregated capacity over the warranty period. The rest of the aggregated drive space may be thin provisioned by the VNM across all the virtualized drives.

Embodiments of the disclosure may include a logic to deal with shrinking drive capacity. The VNM may proportionately redirect traffic to the healthy drives seeing lower Drive Write Per Day (DWPD), which may lower OP the over-provisioning on that drive. If all the drives are seeing similar DWPD, the VNM may equally divide the input/output requests of the shrinking drives to the remaining drives, which may proportionately lower over-provisioning to all the remaining drives. The VNM may use a drive's thin provisioned region to handle redirected writes (for example, for writes for foreign drives). As a result, the system may increase the effective over-provisioning on the shrinking drives (those seeing more failures), because those devices will see fewer writes.

In case a threshold number of are drives shrinking and the guaranteed user promised capacity may be at risk, the VNM may recommend to the user to add spare drives to handle input/output redirection. As a last resort, the VNM may instruct the continuously shrinking drives to operate in a Read Only mode: i.e., the VNM may not allow any further writes to go into those drives to protect existing data written to those drives.

The virtualized drives that support a standard NVMe block interface may report their dynamically shrinking capacity via the NVMe NCAP field.

By controlling over-provisioning from the system/VNM level, embodiments of the disclosure may match over-provisioning to the performance and endurance requirements of the customer. A larger aggregated capacity may be used by applications that require low (DWPD) or with larger input/output sizes.

Embodiments of the disclosure may also offer better fault management. Since SSDs may shrink their capacity rather than reporting themselves as failed, the VNM may use that hint to increase over-provisioning (by allowing fewer writes) on those drives. Embodiments of the disclosure may offer protection against most of the read failures other than sudden uncorrectable media errors on the blocks. Recent data shows that drive Annualized Failure Rate (AFR) is approximately 0.28%: embodiments of the disclosure may reduce the AFR even further. Expensive system level data protection schemes such as Redundant Array of Independent Disks (RAID) and Erasure Coding (EC) may no longer be needed, as most of modern applications have cross system redundancy scheme built in. By avoiding RAID/EC, system performance and endurance may increase.

The following discussion is intended to provide a brief, general description of a suitable machine or machines in which certain aspects of the disclosure may be implemented. The machine or machines may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines may include embedded controllers, such as programmable or non-programmable logic devices or arrays, Application Specific Integrated Circuits (ASICs), embedded computers, smart cards, and the like. The machine or machines may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciate that network communication may utilize various wired and/or wireless short range or long range carriers and protocols, including radio frequency (RF), satellite, microwave, Institute of Electrical and Electronics Engineers (IEEE) 802.11, Bluetooth®, optical, infrared, cable, laser, etc.

Embodiments of the present disclosure may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Embodiments of the disclosure may include a tangible, non-transitory machine-readable medium comprising instructions executable by one or more processors, the instructions comprising instructions to perform the elements of the disclosures as described herein.

The various operations of methods described above may be performed by any suitable means capable of performing the operations, such as various hardware and/or software component(s), circuits, and/or module(s). The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Having described and illustrated the principles of the disclosure with reference to illustrated embodiments, it will be recognized that the illustrated embodiments may be modified in arrangement and detail without departing from such principles, and may be combined in any desired manner. And, although the foregoing discussion has focused on particular embodiments, other configurations are contemplated. In particular, even though expressions such as “according to an embodiment of the disclosure” or the like are used herein, these phrases are meant to generally reference embodiment possibilities, and are not intended to limit the disclosure to particular embodiment configurations. As used herein, these terms may reference the same or different embodiments that are combinable into other embodiments.

The foregoing illustrative embodiments are not to be construed as limiting the disclosure thereof. Although a few embodiments have been described, those skilled in the art will readily appreciate that many modifications are possible to those embodiments without materially departing from the novel teachings and advantages of the present disclosure. Accordingly, all such modifications are intended to be included within the scope of this disclosure as defined in the claims.

Embodiments of the disclosure may extend to the following statements, without limitation:

Statement 1. An embodiment of the disclosure includes a Solid State Disk (SSD), comprising:
a flash storage medium; and
a controller to access a data on the flash storage medium,
wherein the SSD is configured to advertise a physical capacity of the flash storage medium to a Virtual Storage Manager (VSM).

Statement 2. An embodiment of the disclosure includes the SSD according to statement 1, wherein the SSD is configured to advertise the physical capacity of the flash storage medium as a logical capacity of the SSD to the VSM.

Statement 3. An embodiment of the disclosure includes the SSD according to statement 1, wherein the SSD is configured to advertise the physical capacity of the flash storage medium without reserving storage on the flash storage media for over-provisioning.

Statement 4. An embodiment of the disclosure includes the SSD according to statement 1, wherein the physical capacity of the flash storage medium is less than a target capacity for the flash storage medium.

Statement 5. An embodiment of the disclosure includes the SSD according to statement 1, wherein the flash storage medium includes a number of failed blocks.

Statement 6. An embodiment of the disclosure includes the SSD according to statement 1, wherein the SSD is configured to update the physical capacity of the flash storage medium to a second physical capacity based at least in part on a block in the flash storage medium failing.

Statement 7. An embodiment of the disclosure includes the SSD according to statement 6, wherein the SSD is configured to advertise the updated physical capacity of the flash storage medium to the VSM.

Statement 8. An embodiment of the disclosure includes the SSD according to statement 7, wherein the SSD is configured to send a message to the VSM including the updated physical capacity.

Statement 9. An embodiment of the disclosure includes the SSD according to statement 8, wherein the SSD is configured to send the message to the VSM including the updated physical capacity based at least in part on receiving a request from the VSM for the updated physical capacity.

Statement 10. An embodiment of the disclosure includes the SSD according to statement 8, wherein:
the SSD is configured to send an interrupt to the VSM; and
the SSD is configured to send the message to the VSM including the updated physical capacity based at least in part on the interrupt.

Statement 11. An embodiment of the disclosure includes the SSD according to statement 1, wherein the SSD is configured to determine an error count in the flash storage medium based at least in part on a block in the flash storage medium failing.

Statement 12. An embodiment of the disclosure includes the SSD according to statement 11, wherein the SSD is configured to advertise the error count of the flash storage medium to the VSM.

Statement 13. An embodiment of the disclosure includes the SSD according to statement 12, wherein the SSD is configured to send a message to the VSM including the error count.

Statement 14. An embodiment of the disclosure includes the SSD according to statement 13, wherein the SSD is configured to send the message to the VSM including the error count based at least in part on receiving a request from the VSM for the error count.

Statement 15. An embodiment of the disclosure includes the SSD according to statement 13, wherein:
the SSD is configured to send an interrupt to the VSM; and
the SSD is configured to send the message to the VSM including the error count based at least in part on the interrupt.

Statement 16. An embodiment of the disclosure includes the SSD according to statement 1, wherein the SSD is further configured to support thin provisioning.

Statement 17. An embodiment of the disclosure includes the SSD according to statement 1, further comprising a firmware to advertise the physical capacity of the flash storage medium to the VSM.

Statement 18. An embodiment of the disclosure includes a Virtual Storage Manager (VSM), comprising:
a tracking module to track a first physical capacity of a first storage device and a second physical capacity of a second storage device;
an aggregation module to determine a usable capacity of a virtual storage device based at least in part on the first physical capacity of the first storage device and the second physical capacity of the second storage device; and
an allocation module to allocate a first portion of the first storage device and a second portion of the second storage device to an application executing on a processor based at least in part on the usable capacity of the virtual storage device.

Statement 19. An embodiment of the disclosure includes the VSM according to statement 18, wherein the VSM executes on the processor.

Statement 20. An embodiment of the disclosure includes the VSM according to statement 19, wherein the VSM executes in at least one of a kernel space of an operating system executing on the processor or a user space of the operating system executing on the processor.

Statement 21. An embodiment of the disclosure includes the VSM according to statement 18, further comprising an advertising module to advertise the usable capacity to the application executing on the processor.

Statement 22. An embodiment of the disclosure includes the VSM according to statement 21, wherein the advertising module is configured to advertise the usable capacity of a virtual storage device to the application executing on the processor.

Statement 23. An embodiment of the disclosure includes the VSM according to statement 18, wherein:
the aggregation module includes an over-provisioning module to determine a first over-provisioning of the first storage device and to determine a second over-provisioning of the second storage device; and
the aggregation module is configured to determine the usable capacity of the virtual storage device based at least in part on the first physical capacity of the first storage device, the first over-provisioning of the first storage device, the second physical capacity of the second storage device, and the second over-provisioning of the second storage device.

Statement 24. An embodiment of the disclosure includes the VSM according to statement 23, wherein the over-provisioning module is configured to determine the first over-provisioning of the first storage device based at least in part on a workload of the application executing on the processor.

Statement 25. An embodiment of the disclosure includes the VSM according to statement 18, wherein:
the first portion of the first storage device includes a first size;
the second portion of the second storage device includes a second size; and
a combination of the first size and the second size is at least as large as a storage size requested by the application executing on the processor.

Statement 26. An embodiment of the disclosure includes the VSM according to statement 18, wherein the allocation module is configured to:
determine a relative percentage of the usable capacity based at least in part on a storage size requested by the application executing on the processor;
allocate the first portion of the first storage device to the application executing on the processor based at least in part on the relative percentage of the first physical capacity of the first storage device; and
allocate the second portion of the second storage device to the application executing on the processor based at least in part on the relative percentage of the second physical capacity of the first storage device.

Statement 27. An embodiment of the disclosure includes the VSM according to statement 18, wherein the allocation module is configured to:
reserve the first portion of the first storage device to the application executing on the processor;
reserve the second portion of the second storage device to the application executing on the processor;
allocate a first section of the first portion of the first storage device based at least in part on receiving a first write request from the application executing on the processor; and
allocate a second section of the second portion of the second storage device based at least in part on receiving a second write request from the application executing on the processor.

Statement 28. An embodiment of the disclosure includes the VSM according to statement 18, wherein the tracking module is configured to receive an updated physical capacity of the first storage device from the first storage device.

Statement 29. An embodiment of the disclosure includes the VSM according to statement 28, wherein the tracking module is configured to receive a message from the first storage device, the message from the first storage device including the updated physical capacity of the first storage device.

Statement 30. An embodiment of the disclosure includes the VSM according to statement 29, wherein the tracking module is further configured to request the message from the first storage device.

Statement 31. An embodiment of the disclosure includes the VSM according to statement 30, wherein the tracking module is further configured to request the message from the first storage device based at least in part on an interrupt from the first storage device.

Statement 32. An embodiment of the disclosure includes the VSM according to statement 30, wherein the tracking module is further configured to periodically request the message from the first storage device.

Statement 33. An embodiment of the disclosure includes the VSM according to statement 18, wherein the tracking module is configured to receive an error count of the first storage device from the first storage device.

Statement 34. An embodiment of the disclosure includes the VSM according to statement 33, wherein the tracking module is configured to receive a message from the first storage device, the message from the first storage device including the error count of the first storage device.

Statement 35. An embodiment of the disclosure includes the VSM according to statement 34, wherein the tracking module is further configured to request the message from the first storage device.

Statement 36. An embodiment of the disclosure includes the VSM according to statement 35, wherein the tracking module is further configured to request the message from the first storage device based at least in part on an interrupt from the first storage device.

Statement 37. An embodiment of the disclosure includes the VSM according to statement 35, wherein the tracking module is further configured to periodically request the message from the first storage device.

Statement 38. An embodiment of the disclosure includes the VSM according to statement 18, wherein the VSM is configured to set the first storage device in a read-only mode based at least in part on an updated physical capacity of the first storage device or an error count of the first storage device.

Statement 39. An embodiment of the disclosure includes the VSM according to statement 38, wherein the VSM is configured to read a data from the first storage device and to write the data based at least in part on the first storage device being in a read-only mode.

Statement 40. An embodiment of the disclosure includes the VSM according to statement 39, wherein the VSM is further configured to write the first data to the second storage device.

Statement 41. An embodiment of the disclosure includes the VSM according to statement 39, wherein the VSM is further configured to write the first data to a third storage device.

Statement 42. An embodiment of the disclosure includes the VSM according to statement 39, wherein the VSM is further configured to erase the first data from the first storage device.

Statement 43. An embodiment of the disclosure includes the VSM according to statement 18, further comprising a mapping module to map a logical address used by the application executing on the processor to an address on one of the first storage device or the second storage device.

Statement 44. An embodiment of the disclosure includes the VSM according to statement 43, wherein the mapping module is configured to map the logical address used by the application executing on the processor to an address on one of the first storage device or the second storage device and to an identifier of the first storage device or the second storage device.

Statement 45. An embodiment of the disclosure includes the VSM according to statement 43, further comprising a sending module to send a write request to one of the first storage device or the second storage device, the write request including the address.

Statement 46. An embodiment of the disclosure includes the VSM according to statement 43, further comprising a sending module to send a read request to one of the first storage device or the second storage device, the read request including the address.

Statement 47. An embodiment of the disclosure includes a method, comprising:
receiving a first physical capacity of a first storage device from the first storage device;
determining a first logical capacity of the first storage device based at least in part on the first physical capacity of the first storage device;
receiving a second physical capacity of a second storage device from the second storage device;
determining a second logical capacity of the second storage device based at least in part on the second physical capacity of the second storage device;
aggregating the first logical capacity of the first storage device and the second logical capacity of the second storage device to produce a usable capacity; and
advertising the usable capacity to an application executing on a processor.

Statement 48. An embodiment of the disclosure includes the method according to statement 47, wherein the method executes on the processor.

Statement 49. An embodiment of the disclosure includes the method according to statement 48, wherein the method executes as a Virtual Storage Manager (VSM) on the processor.

Statement 50. An embodiment of the disclosure includes the method according to statement 49, wherein the VSM executes in at least one of a kernel space of an operating system executing on the processor or a user space of the operating system executing on the processor.

Statement 51. An embodiment of the disclosure includes the method according to statement 47, wherein advertising the usable capacity to the application executing on the processor includes advertising the usable capacity of a virtual storage device to the application executing on the processor.

Statement 52. An embodiment of the disclosure includes the method according to statement 47, wherein:
determining the first logical capacity of the first storage device based at least in part on the first physical capacity of the first storage device includes:
   determining a first over-provisioning of the first storage device; and
   determining the first logical capacity of the first storage device based on a difference between the first physical capacity of the first storage device and the first over-provisioning of the first storage device; and
determining the second logical capacity of the second storage device based at least in part on the second physical capacity of the second storage device includes:
   determining a second over-provisioning of the second storage device; and
   determining the second logical capacity of the second storage device based on a difference between the second physical capacity of the second storage device and the second over-provisioning of the second storage device.

Statement 53. An embodiment of the disclosure includes the method according to statement 52, wherein:
determining the first over-provisioning of the first storage device includes determining the first over-provisioning of the first storage device based at least in part on a workload of an application executing on the processor; and
determining the second over-provisioning of the second storage device includes determining the second over-provisioning of the second storage device based at least in part on the workload of the application executing on the processor.

Statement 54. An embodiment of the disclosure includes the method according to statement 53, wherein determining the first logical capacity of the first storage device based at least in part on the first physical capacity of the first storage device further includes receiving the workload of the application executing on the processor ##(110) from the application executing on the processor.

Statement 55. An embodiment of the disclosure includes the method according to statement 47, further comprising:
receiving a request to allocate a storage size from the application executing on the processor, wherein the storage size is less than the usable capacity;
reserving a first portion of the first storage device to the application executing on the processor, the first portion of the first storage device including a first size; and
reserving a second portion of the second storage device to the application executing on the processor, the second portion of the second storage device including a second size,
wherein a combination of the first size of the first portion of the first storage device and the second size of the second portion of the second storage device is at least as large as the storage size.

Statement 56. An embodiment of the disclosure includes the method according to statement 55, wherein:
the method further comprises determining the storage size as a relative percentage of the usable capacity;
reserving the first portion of the first storage device to the application executing on the processor includes determining the first portion of the first storage device as the relative percentage of the first logical capacity of the first storage device; and
reserving the second portion of the second storage device to the application executing on the processor includes determining the second portion of the second storage device as the relative percentage of the second logical capacity of the second storage device.

Statement 57. An embodiment of the disclosure includes the method according to statement 55, further comprising:
determining a first difference for the first storage device, the first difference calculated between the first size of the first portion of the first storage device and the first logical capacity of the first storage device;
determining a second difference for the second storage device, the second difference calculated between the second size of the second portion of the second storage device and the second logical capacity of the second storage device;
using the first difference as an over-provisioning for the first storage device; and
using the second difference as an over-provisioning for the second storage device.

Statement 58. An embodiment of the disclosure includes the method according to statement 55, further comprising:
receiving a second request to allocate a second storage size from a second application executing on the processor, wherein a second combination of the storage size and the second storage size is less than the usable capacity;
reserving a third portion of the first logical capacity of the first storage device to the second application executing on the processor; and
reserving a fourth portion of the second logical capacity of the second storage device to the second application executing on the processor,
wherein a third combination of the third portion of the first logical capacity of the first storage device and the fourth portion of the second logical capacity of the second storage device is at least as large as the second storage size.

Statement 59. An embodiment of the disclosure includes the method according to statement 55, further comprising:
receiving a first write request from the application executing on the processor, the first write request including a first data;
allocating a first section of the first portion of the first storage device;
writing the first data to the first section of the first portion of the first storage device;
receiving a second write request from the application executing on the processor, the second write request including a second data;
allocating a second section of the second portion of the second storage device; and
writing the second data to the second section of the second portion of the second storage device.

Statement 60. An embodiment of the disclosure includes the method according to statement 59, wherein:
the first write request further includes a first logical address;
the second write request further includes a second logical address;
writing the first data to the first section of the first portion of the first storage device includes:
   mapping the first logical address to a first address associated with the first storage device; and
   sending a third write request to the first storage device, the third write request including the first data and the first address; and
writing the second data to the second section of the second portion of the second storage device includes:
   mapping the second logical address to a second address associated with the second storage device; and
   sending a fourth write request to the second storage device, the fourth write request including the second data and the second address.

Statement 61. An embodiment of the disclosure includes the method according to statement 60, wherein:
writing the first data to the first section of the first portion of the first storage device includes:
   receiving a first response from the first storage device; and
   sending the first response to the application executing on the processor; and
writing the second data to the second section of the second portion of the second storage device includes:
   receiving a second response from the second storage device; and
   sending the second response to the application executing on the processor.

Statement 62. An embodiment of the disclosure includes the method according to statement 59, further comprising:
receiving a first read request from the application executing on the processor, the first read request including a first logical address;
mapping the first logical address to a first address associated with the first storage device; and
sending a second read request to the first storage device, the second read request including the first address; and
receiving a third read request from the application executing on the processor, the third read request including a second logical address;
mapping the second logical address to a second address associated with the second storage device; and
sending a fourth read request to the second storage device, the fourth read request including the second address.

Statement 63. An embodiment of the disclosure includes the method according to statement 62, wherein:
sending the second read request to the first storage device includes:
   receiving a first response from the first storage device; and
   sending the first response to the application executing on the processor; and
sending the fourth read request to the first storage device includes:
   receiving a second response from the second storage device; and
   sending the second response to the application executing on the processor.

Statement 64. An embodiment of the disclosure includes the method according to statement 55, wherein:
reserving the first portion of the first storage device to the application executing on the processor includes reserving the first portion of the storage device to the application executing on the processor using thin provisioning; and
reserving the second portion of the second storage device to the application executing on the processor includes reserving the second portion of the second storage device to the application executing on the processor to the application executing on the processor using thin provisioning.

Statement 65. An embodiment of the disclosure includes the method according to statement 55, further comprising:
receiving an updated physical capacity of the first storage device from the first storage device;
determining an updated logical capacity of the first storage device based at least in part on the updated physical capacity of the first storage device;
determining that the first size of the first portion of the first storage device is greater than the updated physical capacity of the first storage device; and
setting the first storage device in a read-only mode based at least in part on the first size of the first portion being greater than the updated physical capacity of the first storage device.

Statement 66. An embodiment of the disclosure includes the method according to statement 55, further comprising:
receiving an updated physical capacity of the first storage device from the first storage device;
determining an updated logical capacity of the first storage device based at least in part on the updated physical capacity of the first storage device;
determining that a third size of a first section of the first storage device is greater than the updated logical capacity of the first storage device; and
setting the first storage device in a read-only mode based at least in part on the first size of the first portion being greater than the updated logical capacity of the first storage device.

Statement 67. An embodiment of the disclosure includes the method according to statement 66, further comprising:
reading a first data from the first portion of the first storage device; and
writing the first data.

Statement 68. An embodiment of the disclosure includes the method according to statement 67, wherein writing the first data includes writing the first data to the second section of the second storage device.

Statement 69. An embodiment of the disclosure includes the method according to statement 67, wherein writing the first data includes writing the first data to a third section of a third storage device.

Statement 70. An embodiment of the disclosure includes the method according to statement 67, further comprising erasing the first data from the first storage device.

Statement 71. An embodiment of the disclosure includes the method according to statement 47, further comprising:
receiving an updated physical capacity of the first storage device from the first storage device; and
setting the first storage device in a read-only mode based at least in part on the updated physical capacity of the first storage device.

Statement 72. An embodiment of the disclosure includes the method according to statement 71, wherein receiving the updated physical capacity of the first storage device from the first storage device includes receiving a message from the first storage device, the message including the updated physical capacity of the first storage device.

Statement 73. An embodiment of the disclosure includes the method according to statement 72, wherein receiving the message from the first storage device includes sending a request to the first storage device for the updated physical capacity of the first storage device.

Statement 74. An embodiment of the disclosure includes the method according to statement 73, wherein:
receiving the updated physical capacity of the first storage device from the first storage device includes receiving an interrupt from the first storage device;
sending the request to the first storage device for the updated physical capacity of the first storage device includes sending the request to the first storage device for the updated physical capacity of the first storage device based at least in part on the interrupt.

Statement 75. An embodiment of the disclosure includes the method according to statement 73, wherein sending the request to the first storage device for the updated physical capacity of the first storage device includes periodically sending the request to the first storage device for the updated physical capacity of the first storage device.

Statement 76. An embodiment of the disclosure includes the method according to statement 47, further comprising:
receiving an error count of the first storage device from the first storage device; and
setting the first storage device in a read-only mode based at least in part on the error count of the first storage device.

Statement 77. An embodiment of the disclosure includes the method according to statement 76, wherein receiving the error count of the first storage device from the first storage device includes receiving a message from the first storage device, the message including the error count of the first storage device.

Statement 78. An embodiment of the disclosure includes the method according to statement 77, wherein receiving the message from the first storage device includes sending a request to the first storage device for the error count of the first storage device.

Statement 79. An embodiment of the disclosure includes the method according to statement 78, wherein:
receiving the error count of the first storage device from the first storage device includes receiving an interrupt from the first storage device;
sending the request to the first storage device for the error count of the first storage device includes sending the request to the first storage device for the error count of the first storage device based at least in part on the interrupt.

Statement 80. An embodiment of the disclosure includes the method according to statement 78, wherein sending the request to the first storage device for the error count of the first storage device includes periodically sending the request to the first storage device for the error count of the first storage device.

Statement 81. An embodiment of the disclosure includes a method, comprising:
receiving, at a storage device, a request from a virtual storage manager for a capacity of the storage device; and
sending, from the storage device to the virtual storage manager, a response including a physical capacity of the storage device.

Statement 82. An embodiment of the disclosure includes the method according to statement 81, wherein:
the method further comprises sending, from the storage device to the virtual storage manager, an interrupt; and
receiving, at the storage device, the request from the virtual storage manager for the capacity of the storage device includes receiving, at the storage device, the request from the virtual storage manager for the capacity of the storage device based at least in part on the interrupt.

Statement 83. An embodiment of the disclosure includes the method according to statement 82, wherein the interrupt includes a message signaled interrupt (MSI) or an MSI-extended (MSI-X) interrupt.

Statement 84. An embodiment of the disclosure includes the method according to statement 81, wherein sending, from the storage device to the virtual storage manager, the response including the physical capacity of the storage device includes sending, from the storage device to the virtual storage manager, the response including the physical capacity of the storage device as a logical capacity of the storage device.

Statement 85. An embodiment of the disclosure includes the method according to statement 81, wherein the storage device does not manage an over-provisioning of the storage device.

Statement 86. An embodiment of the disclosure includes the method according to statement 81, further comprising:
receiving, at the storage device, a second request from the virtual storage manager for an updated capacity of the storage device; and
sending, from the storage device to the virtual storage manager, a second response including an updated physical capacity of the storage device.

Statement 87. An embodiment of the disclosure includes the method according to statement 86, wherein:
the method further comprises sending, from the storage device to the virtual storage manager, an interrupt; and
receiving, at the storage device, the request from the virtual storage manager for the updated capacity of the storage device includes receiving, at the storage device, the request from the virtual storage manager for the updated capacity of the storage device based at least in part on the interrupt.

Statement 88. An embodiment of the disclosure includes the method according to statement 87, wherein the interrupt includes an MSI interrupt or an MSI-X interrupt.

Statement 89. An embodiment of the disclosure includes the method according to statement 86, wherein sending, from the storage device to the virtual storage manager, the second response including the updated physical capacity of the storage device includes sending, from the storage device to the virtual storage manager, the second response including the updated physical capacity of the storage device as an updated logical capacity of the storage device.

Statement 90. An embodiment of the disclosure includes the method according to statement 81, further comprising:
receiving, at the storage device, a second request from the virtual storage manager for an error count of the storage device; and
sending, from the storage device to the virtual storage manager, a second response including the error count of the storage device.

Statement 91. An embodiment of the disclosure includes the method according to statement 90, wherein:
the method further comprises sending, from the storage device to the virtual storage manager, an interrupt; and
receiving, at the storage device, the request from the virtual storage manager for the error count of the storage device includes receiving, at the storage device, the request from the virtual storage manager for the error count of the storage device based at least in part on the interrupt.

Statement 92. An embodiment of the disclosure includes the method according to statement 91, wherein the interrupt includes an MSI interrupt or an MSI-X interrupt.

Statement 93. An embodiment of the disclosure includes a system, comprising a non-transitory storage medium, the non-transitory storage medium having stored thereon instructions that, when executed by a machine, result in:
receiving a first physical capacity of a first storage device from the first storage device;
determining a first logical capacity of the first storage device based at least in part on the first physical capacity of the first storage device;
receiving a second physical capacity of a second storage device from the second storage device;
determining a second logical capacity of the second storage device based at least in part on the second physical capacity of the second storage device;
aggregating the first logical capacity of the first storage device and the second logical capacity of the second storage device to produce a usable capacity; and
advertising the usable capacity to an application executing on a processor.

Statement 94. An embodiment of the disclosure includes the system according to statement 93, wherein the method executes on the processor.

Statement 95. An embodiment of the disclosure includes the system according to statement 94, wherein the method executes as a Virtual Storage Manager (VSM) on the processor.

Statement 96. An embodiment of the disclosure includes the system according to statement 95, wherein the VSM executes in at least one of a kernel space of an operating system executing on the processor or a user space of the operating system executing on the processor.

Statement 97. An embodiment of the disclosure includes the system according to statement 93, wherein advertising the usable capacity to the application executing on the processor includes advertising the usable capacity of a virtual storage device to the application executing on the processor.

Statement 98. An embodiment of the disclosure includes the system according to statement 93, wherein:
determining the first logical capacity of the first storage device based at least in part on the first physical capacity of the first storage device includes:
   determining a first over-provisioning of the first storage device; and
   determining the first logical capacity of the first storage device based on a difference between the first physical capacity of the first storage device and the first over-provisioning of the first storage device; and
determining the second logical capacity of the second storage device based at least in part on the second physical capacity of the second storage device includes:
   determining a second over-provisioning of the second storage device; and
   determining the second logical capacity of the second storage device based on a difference between the second physical capacity of the second storage device and the second over-provisioning of the second storage device.

Statement 99. An embodiment of the disclosure includes the system according to statement 98, wherein:
determining the first over-provisioning of the first storage device includes determining the first over-provisioning of the first storage device based at least in part on a workload of an application executing on the processor; and
determining the second over-provisioning of the second storage device includes determining the second over-provisioning of the second storage device based at least in part on the workload of the application executing on the processor.

Statement 100. An embodiment of the disclosure includes the system according to statement 99, wherein determining the first logical capacity of the first storage device based at least in part on the first physical capacity of the first storage device further includes receiving the workload of the application executing on the processor ##(110) from the application executing on the processor.

Statement 101. An embodiment of the disclosure includes the system according to statement 93, the non-transitory storage medium having stored thereon further instructions that, when executed by the machine, result in:
receiving a request to allocate a storage size from the application executing on the processor, wherein the storage size is less than the usable capacity;
reserving a first portion of the first storage device to the application executing on the processor, the first portion of the first storage device including a first size; and
reserving a second portion of the second storage device to the application executing on the processor, the second portion of the second storage device including a second size,
wherein a combination of the first size of the first portion of the first storage device and the second size of the second portion of the second storage device is at least as large as the storage size.

Statement 102. An embodiment of the disclosure includes the system according to statement 101, wherein:
the non-transitory storage medium has stored thereon further instructions that, when executed by the machine, result in determining the storage size as a relative percentage of the usable capacity;
reserving the first portion of the first storage device to the application executing on the processor includes determining the first portion of the first storage device as the relative percentage of the first logical capacity of the first storage device; and
reserving the second portion of the second storage device to the application executing on the processor includes determining the second portion of the second storage device as the relative percentage of the second logical capacity of the second storage device.

Statement 103. An embodiment of the disclosure includes the system according to statement 101, the non-transitory storage medium having stored thereon further instructions that, when executed by the machine, result in:
determining a first difference for the first storage device, the first difference calculated between the first size of the first portion of the first storage device and the first logical capacity of the first storage device;
determining a second difference for the second storage device, the second difference calculated between the second size of the second portion of the second storage device and the second logical capacity of the second storage device;
using the first difference as an over-provisioning for the first storage device; and
using the second difference as an over-provisioning for the second storage device.

Statement 104. An embodiment of the disclosure includes the system according to statement 101, the non-transitory storage medium having stored thereon further instructions that, when executed by the machine, result in:
receiving a second request to allocate a second storage size from a second application executing on the processor, wherein a second combination of the storage size and the second storage size is less than the usable capacity;
reserving a third portion of the first logical capacity of the first storage device to the second application executing on the processor; and
reserving a fourth portion of the second logical capacity of the second storage device to the second application executing on the processor,
wherein a third combination of the third portion of the first logical capacity of the first storage device and the fourth portion of the second logical capacity of the second storage device is at least as large as the second storage size.

Statement 105. An embodiment of the disclosure includes the system according to statement 101, the non-transitory storage medium having stored thereon further instructions that, when executed by the machine, result in:
receiving a first write request from the application executing on the processor, the first write request including a first data;
allocating a first section of the first portion of the first storage device;
writing the first data to the first section of the first portion of the first storage device;
receiving a second write request from the application executing on the processor, the second write request including a second data;
allocating a second section of the second portion of the second storage device; and
writing the second data to the second section of the second portion of the second storage device.

Statement 106. An embodiment of the disclosure includes the system according to statement 105, the non-transitory storage medium having stored thereon further instructions that, when executed by the machine, result in:
receiving an updated physical capacity of the first storage device from the first storage device;
determining an updated logical capacity of the first storage device based at least in part on the updated physical capacity of the first storage device;
determining that a third size of the first section of the first storage device is greater than the updated logical capacity of the first storage device; and
setting the first storage device in a read-only mode based at least in part on the first size of the first portion being greater than the updated logical capacity of the first storage device.

Statement 107. An embodiment of the disclosure includes the system according to statement 106, the non-transitory storage medium having stored thereon further instructions that, when executed by the machine, result in:
reading the first data from the first portion of the first storage device; and
writing the first data.

Statement 108. An embodiment of the disclosure includes the system according to statement 107, wherein writing the first data includes writing the first data to the second section of the second storage device.

Statement 109. An embodiment of the disclosure includes the system according to statement 107, wherein writing the first data includes writing the first data to a third section of a third storage device.

Statement 110. An embodiment of the disclosure includes the system according to statement 107, the non-transitory storage medium having stored thereon further instructions that, when executed by the machine, result in erasing the first data from the first storage device.

Statement 111. An embodiment of the disclosure includes the system according to statement 105, wherein:
the first write request further includes a first logical address;
the second write request further includes a second logical address;
writing the first data to the first section of the first portion of the first storage device includes:
   mapping the first logical address to a first address associated with the first storage device; and
   sending a third write request to the first storage device, the third write request including the first data and the first address; and
writing the second data to the second section of the second portion of the second storage device includes:
   mapping the second logical address to a second address associated with the second storage device; and
   sending a fourth write request to the second storage device, the fourth write request including the second data and the second address.

Statement 112. An embodiment of the disclosure includes the system according to statement 111, wherein:
writing the first data to the first section of the first portion of the first storage device includes:
   receiving a first response from the first storage device; and
   sending the first response to the application executing on the processor; and
writing the second data to the second section of the second portion of the second storage device includes:
   receiving a second response from the second storage device; and
   sending the second response to the application executing on the processor.

Statement 113. An embodiment of the disclosure includes the system according to statement 105, the non-transitory storage medium having stored thereon further instructions that, when executed by the machine, result in:
receiving a first read request from the application executing on the processor, the first read request including a first logical address;
mapping the first logical address to a first address associated with the first storage device; and
sending a second read request to the first storage device, the second read request including the first address; and
receiving a third read request from the application executing on the processor, the third read request including a second logical address;
mapping the second logical address to a second address associated with the second storage device; and
sending a fourth read request to the second storage device, the fourth read request including the second address.

Statement 114. An embodiment of the disclosure includes the system according to statement 113, wherein:
sending the second read request to the first storage device includes:
   receiving a first response from the first storage device; and
   sending the first response to the application executing on the processor; and
sending the fourth read request to the first storage device includes:
   receiving a second response from the second storage device; and
   sending the second response to the application executing on the processor.

Statement 115. An embodiment of the disclosure includes the system according to statement 101, wherein:
reserving the first portion of the first storage device to the application executing on the processor includes reserving the first portion of the storage device to the application executing on the processor using thin provisioning; and
reserving the second portion of the second storage device to the application executing on the processor includes reserving the second portion of the second storage device to the application executing on the processor to the application executing on the processor using thin provisioning.

Statement 116. An embodiment of the disclosure includes the system according to statement 101, the non-transitory storage medium having stored thereon further instructions that, when executed by the machine, result in:
receiving an updated physical capacity of the first storage device from the first storage device;
determining an updated logical capacity of the first storage device based at least in part on the updated physical capacity of the first storage device;
determining that the first size of the first portion of the first storage device is greater than the updated physical capacity of the first storage device; and
setting the first storage device in a read-only mode based at least in part on the first size of the first portion being greater than the updated physical capacity of the first storage device.

Statement 117. An embodiment of the disclosure includes the system according to statement 93, the non-transitory storage medium having stored thereon further instructions that, when executed by the machine, result in:
receiving an updated physical capacity of the first storage device from the first storage device; and
setting the first storage device in a read-only mode based at least in part on the updated physical capacity of the first storage device.

Statement 118. An embodiment of the disclosure includes the system according to statement 117, wherein receiving the updated physical capacity of the first storage device from the first storage device includes receiving a message from the first storage device, the message including the updated physical capacity of the first storage device.

Statement 119. An embodiment of the disclosure includes the system according to statement 118, wherein receiving the message from the first storage device includes sending a request to the first storage device for the updated physical capacity of the first storage device.

Statement 120. An embodiment of the disclosure includes the system according to statement 119, wherein:
receiving the updated physical capacity of the first storage device from the first storage device includes receiving an interrupt from the first storage device;
sending the request to the first storage device for the updated physical capacity of the first storage device includes sending the request to the first storage device for the updated physical capacity of the first storage device based at least in part on the interrupt.

Statement 121. An embodiment of the disclosure includes the system according to statement 119, wherein sending the request to the first storage device for the updated physical capacity of the first storage device includes periodically sending the request to the first storage device for the updated physical capacity of the first storage device.

Statement 122. An embodiment of the disclosure includes the system according to statement 93, the non-transitory storage medium having stored thereon further instructions that, when executed by the machine, result in:
receiving an error count of the first storage device from the first storage device; and
setting the first storage device in a read-only mode based at least in part on the error count of the first storage device.

Statement 123. An embodiment of the disclosure includes the system according to statement 122, wherein receiving the error count of the first storage device from the first storage device includes receiving a message from the first storage device, the message including the error count of the first storage device.

Statement 124. An embodiment of the disclosure includes the system according to statement 123, wherein receiving the message from the first storage device includes sending a request to the first storage device for the error count of the first storage device.

Statement 125. An embodiment of the disclosure includes the system according to statement 124, wherein:
receiving the error count of the first storage device from the first storage device includes receiving an interrupt from the first storage device;
sending the request to the first storage device for the error count of the first storage device includes sending the request to the first storage device for the error count of the first storage device based at least in part on the interrupt.

Statement 126. An embodiment of the disclosure includes the system according to statement 124, wherein sending the request to the first storage device for the error count of the first storage device includes periodically sending the request to the first storage device for the error count of the first storage device.

Statement 127. An embodiment of the disclosure includes a system, comprising a non-transitory storage medium, the non-transitory storage medium having stored thereon instructions that, when executed by a machine, result in:
receiving, at a storage device, a request from a virtual storage manager for a capacity of the storage device; and
sending, from the storage device to the virtual storage manager, a response including a physical capacity of the storage device.

Statement 128. An embodiment of the disclosure includes the system according to statement 127, wherein:
the non-transitory storage medium has stored thereon further instructions that, when executed by the machine, result in sending, from the storage device to the virtual storage manager, an interrupt; and
receiving, at the storage device, the request from the virtual storage manager for the capacity of the storage device includes receiving, at the storage device, the request from the virtual storage manager for the capacity of the storage device based at least in part on the interrupt.

Statement 129. An embodiment of the disclosure includes the system according to statement 128, wherein the interrupt includes a message signaled interrupt (MSI) or an MSI-extended (MSI-X) interrupt.

Statement 130. An embodiment of the disclosure includes the system according to statement 127, wherein sending, from the storage device to the virtual storage manager, the response including the physical capacity of the storage device includes sending, from the storage device to the virtual storage manager, the response including the physical capacity of the storage device as a logical capacity of the storage device.

Statement 131. An embodiment of the disclosure includes the system according to statement 127, wherein the storage device does not manage an over-provisioning of the storage device.

Statement 132. An embodiment of the disclosure includes the system according to statement 127, the non-transitory storage medium having stored thereon further instructions that, when executed by the machine, result in:
receiving, at the storage device, a second request from the virtual storage manager for an updated capacity of the storage device; and
sending, from the storage device to the virtual storage manager, a second response including an updated physical capacity of the storage device.

Statement 133. An embodiment of the disclosure includes the system according to statement 132, wherein:
the non-transitory storage medium has stored thereon further instructions that, when executed by the machine, result in sending, from the storage device to the virtual storage manager, an interrupt; and
receiving, at the storage device, the request from the virtual storage manager for the updated capacity of the storage device includes receiving, at the storage device, the request from the virtual storage manager for the updated capacity of the storage device based at least in part on the interrupt.

Statement 134. An embodiment of the disclosure includes the system according to statement 133, wherein the interrupt includes an MSI interrupt or an MSI-X interrupt.

Statement 135. An embodiment of the disclosure includes the system according to statement 132, wherein sending, from the storage device to the virtual storage manager, the second response including the updated physical capacity of the storage device includes sending, from the storage device to the virtual storage manager, the second response including the updated physical capacity of the storage device as an updated logical capacity of the storage device.

Statement 136. An embodiment of the disclosure includes the system according to statement 127, the non-transitory storage medium having stored thereon further instructions that, when executed by the machine, result in:
receiving, at the storage device, a second request from the virtual storage manager for an error count of the storage device; and
sending, from the storage device to the virtual storage manager, a second response including the error count of the storage device.

Statement 137. An embodiment of the disclosure includes the system according to statement 136, wherein:
the non-transitory storage medium has stored thereon further instructions that, when executed by the machine, result in sending, from the storage device to the virtual storage manager, an interrupt; and
receiving, at the storage device, the request from the virtual storage manager for the error count of the storage device includes receiving, at the storage device, the request from the virtual storage manager for the error count of the storage device based at least in part on the interrupt.

Statement 138. An embodiment of the disclosure includes the system according to statement 137, wherein the interrupt includes an MSI interrupt or an MSI-X interrupt.

Consequently, in view of the wide variety of permutations to the embodiments described herein, this detailed description and accompanying material is intended to be illustrative only, and should not be taken as limiting the scope of the disclosure. What is claimed as the disclosure, therefore, is all such modifications as may come within the scope and spirit of the following claims and equivalents thereto.

What is claimed is:

1. A Solid State Disk (SSD), comprising:
a flash storage medium; and
a controller to access a data on the flash storage medium,
wherein the SSD is configured to advertise a physical capacity of the flash storage medium to a Virtual Storage Manager (VSM).

2. The SSD according to claim 1, wherein the SSD is configured to update the physical capacity of the flash storage medium to a second physical capacity based at least in part on a block in the flash storage medium failing.

3. The SSD according to claim 2, wherein the SSD is configured to advertise the updated physical capacity of the flash storage medium to the VSM.

4. The SSD according to claim 1, wherein the SSD is further configured to support thin provisioning.

5. The SSD according to claim 1, further comprising a firmware to advertise the physical capacity of the flash storage medium to the VSM.

6. A Virtual Storage Manager (VSM), comprising:
a tracking module to track a first physical capacity of a first storage device and a second physical capacity of a second storage device;
an aggregation module to determine a usable capacity of a virtual storage device based at least in part on the first physical capacity of the first storage device and the second physical capacity of the second storage device; and
an allocation module to allocate a first portion of the first storage device and a second portion of the second storage device to an application executing on a processor based at least in part on the usable capacity of the virtual storage device.

7. The VSM according to claim 6, further comprising an advertising module to advertise the usable capacity to the application executing on the processor.

8. The VSM according to claim 6, wherein:
the aggregation module includes an over-provisioning module to determine a first over-provisioning of the first storage device and to determine a second over-provisioning of the second storage device; and
the aggregation module is configured to determine the usable capacity of the virtual storage device based at least in part on the first physical capacity of the first storage device, the first over-provisioning of the first storage device, the second physical capacity of the second storage device, and the second over-provisioning of the second storage device.

9. The VSM according to claim 6, wherein:
the first portion of the first storage device includes a first size;
the second portion of the second storage device includes a second size; and
a combination of the first size and the second size is at least as large as a storage size requested by the application executing on the processor.

10. The VSM according to claim 6, wherein the allocation module is configured to:
determine a relative percentage of the usable capacity based at least in part on a storage size requested by the application executing on the processor;
allocate the first portion of the first storage device to the application executing on the processor based at least in part on the relative percentage of the first physical capacity of the first storage device; and
allocate the second portion of the second storage device to the application executing on the processor based at least in part on the relative percentage of the second physical capacity of the first storage device.

11. The VSM according to claim 6, wherein the allocation module is configured to:
reserve the first portion of the first storage device to the application executing on the processor;
reserve the second portion of the second storage device to the application executing on the processor;
allocate a first section of the first portion of the first storage device based at least in part on receiving a first write request from the application executing on the processor; and
allocate a second section of the second portion of the second storage device based at least in part on receiving a second write request from the application executing on the processor.

12. The VSM according to claim 6, wherein the VSM is configured to set the first storage device in a read-only mode based at least in part on an updated physical capacity of the first storage device or an error count of the first storage device.

13. The VSM according to claim 6, further comprising a mapping module to map a logical address used by the application executing on the processor to an address on one of the first storage device or the second storage device.

14. A method, comprising:
receiving a first physical capacity of a first storage device from the first storage device;
determining a first logical capacity of the first storage device based at least in part on the first physical capacity of the first storage device;
receiving a second physical capacity of a second storage device from the second storage device;
determining a second logical capacity of the second storage device based at least in part on the second physical capacity of the second storage device;
aggregating the first logical capacity of the first storage device and the second logical capacity of the second storage device to produce a usable capacity; and
advertising the usable capacity to an application executing on a processor.

15. The method according to claim 14, wherein advertising the usable capacity to the application executing on the processor includes advertising the usable capacity of a virtual storage device to the application executing on the processor.

16. The method according to claim 14, wherein:
determining the first logical capacity of the first storage device based at least in part on the first physical capacity of the first storage device includes:
determining a first over-provisioning of the first storage device; and
determining the first logical capacity of the first storage device based on a difference between the first physical capacity of the first storage device and the first over-provisioning of the first storage device; and
determining the second logical capacity of the second storage device based at least in part on the second physical capacity of the second storage device includes:
determining a second over-provisioning of the second storage device; and
determining the second logical capacity of the second storage device based on a difference between the second physical capacity of the second storage device and the second over-provisioning of the second storage device.

17. The method according to claim 14, further comprising:
receiving a request to allocate a storage size from the application executing on the processor, wherein the storage size is less than the usable capacity;
reserving a first portion of the first storage device to the application executing on the processor, the first portion of the first storage device including a first size; and
reserving a second portion of the second storage device to the application executing on the processor, the second portion of the second storage device including a second size,
wherein a combination of the first size of the first portion of the first storage device and the second size of the second portion of the second storage device is at least as large as the storage size.

18. The method according to claim 17, wherein:
reserving the first portion of the first storage device to the application executing on the processor includes reserving the first portion of the storage device to the application executing on the processor using thin provisioning; and
reserving the second portion of the second storage device to the application executing on the processor includes reserving the second portion of the second storage device to the application executing on the processor to the application executing on the processor using thin provisioning.

19. The method according to claim 17, further comprising:
receiving an updated physical capacity of the first storage device from the first storage device;
determining an updated logical capacity of the first storage device based at least in part on the updated physical capacity of the first storage device;
determining that the first size of the first portion of the first storage device is greater than the updated logical capacity of the first storage device; and
setting the first storage device in a read-only mode based at least in part on the first size of the first portion being greater than the updated logical capacity of the first storage device.

20. The method according to claim 19, further comprising:
reading the first data from the first portion of the first storage device; and
writing the first data.
